(19) United States
(12) Patent Application Publication
(10) Pub. No.: US 2026/0196228 A1
(43) Pub. Date: Jul. 9, 2026

(54) PARAMETRIC SPATIAL AUDIO ENCODING

(71) Applicant: NOKIA TECHNOLOGIES OY, Espoo (FI)

(72) Inventors: Adriana VASILACHE, Tampere (FI); Mikko-Ville LAITINEN, Espoo (FI)

(21) Appl. No.: 19/133,782

(22) PCT Filed: Nov. 7, 2023
(86) PCT No.: PCT/EP2023/080896

§ 371 Date: May 29, 2025

(30) Foreign Application Priority Data
Nov. 29, 2022 (GB) 2217905.5

(51) Int. Cl. G10L 19/035

(52) U.S. Cl. CPC G10L 19/035

(57) ABSTRACT

An apparatus for encoding an audio object parameter, the apparatus comprising means for: obtaining, for time-frequency elements of a frame comprising more than one time element and more than one frequency element, a plurality of ratio parameters for an audio object within an audio environment, the audio environment comprising more than one audio object and the ratio parameters configured to identify a distribution of a specific object within the object part of the total audio environment and for a specific time-frequency element; quantizing selections of the ratio parameters, wherein the selections are associated with audio objects within a specific frame time-frequency element; encoding a first set of the selections of ratio parameters based on an indexing of the selections; and encoding the remaining selections of the ratio parameters for the frame based on a differential encoding of the selections based on the first set of selection of ratio parameters or a precedingly indexed time element or frequency element selection of ratio parameters.

### FIELD

The present application relates to apparatus and methods for spatial audio representation and encoding, but not exclusively for audio representation for an audio encoder.

### BACKGROUND

Parametric spatial audio processing is a field of audio signal processing where the spatial aspect of the sound is described using a set of parameters. For example, in parametric spatial audio capture from microphone arrays, it is a typical and an effective choice to estimate from the microphone array signals a set of parameters such as directions of the sound in frequency bands, and the ratios between the directional and non-directional parts of the captured sound in frequency bands. These parameters are known to well describe the perceptual spatial properties of the captured sound at the position of the microphone array. These parameters can be utilized in synthesis of the spatial sound accordingly, for headphones binaurally, for loudspeakers, or to other formats, such as Ambisonics.

The directions and direct-to-total energy ratios in frequency bands are thus a parameterization that is particularly effective for spatial audio capture.

A parameter set consisting of a direction parameter in frequency bands and an energy ratio parameter in frequency bands (indicating the directionality of the sound) can be also utilized as the spatial metadata (which may also include other parameters such as surround coherence, spread coherence, number of directions, distance etc) for an audio codec. For example, these parameters can be estimated from microphone-array captured audio signals, and for example a stereo or mono signal can be generated from the microphone array signals to be conveyed with the spatial metadata.

Immersive audio codecs are being implemented supporting a multitude of operating points ranging from a low bit rate operation to transparency. An example of such a codec is the Immersive Voice and Audio Services (IVAS) codec which is being designed to be suitable for use over a communications network such as a 3GPP 4G/5G network including use in such immersive services as for example immersive voice and audio for virtual reality (VR). This audio codec is expected to handle the encoding, decoding and rendering of speech, music and generic audio. It is furthermore expected to support channel-based audio and scene-based audio inputs including spatial information about the sound field and sound sources. The codec is also expected to operate with low latency to enable conversational services as well as support high error robustness under various transmission conditions.

The stereo signal could be encoded, for example, with an AAC encoder and the mono signal could be encoded with an EVS encoder. A decoder can decode the audio signals into PCM signals and process the sound in frequency bands (using the spatial metadata) to obtain the spatial output, for example a binaural output.

The aforementioned immersive audio codecs are particularly suitable for encoding captured spatial sound from microphone arrays (e.g., in mobile phones, VR cameras, stand-alone microphone arrays). However, such an encoder can have other input types, for example, loudspeaker signals, audio object signals, Ambisonic signals.

### SUMMARY

According to a first aspect there is provided an apparatus for encoding an audio object parameter, the apparatus comprising means for: obtaining, for time-frequency elements of a frame comprising more than one time element and more than one frequency element, a plurality of ratio parameters for an audio object within an audio environment, the audio environment comprising more than one audio object and the ratio parameters configured to identify a distribution of a specific object within the object part of the total audio environment and for a specific time-frequency element; quantizing selections of the ratio parameters, wherein the selections are associated with audio objects within a specific frame time-frequency element; encoding a first set of the selections of ratio parameters based on an indexing of the selections; and encoding the remaining selections of the ratio parameters for the frame based on a differential encoding of the selections based on the first set of selection of ratio parameters or a precedingly indexed time element or frequency element selection of ratio parameters.

The selections may be vectors of the ratio parameters and the means may be further for generating the vectors of the ratio parameters representing the ratio parameters.

The means for encoding a first set of the selections of ratio parameters based on an indexing of the selections may be for generating an integer value based on an indexing from the selection, wherein the generated integer value represents the ratio parameters for the audio objects.

The means for generating the integer value based on the indexing from the selection of ratio parameters may be for: generating a single number value by appending elements from the selection of ratio parameters; and generating the index from the single number, by performing an iteration loop from a zeroth iteration up to and including the single number of iterations and sequentially associating index values to iteration loop iteration numbers which have a valid selection of ratio parameters, wherein the integer value is the highest index value.

The means for quantizing the selection of the ratio parameters may be for: quantizing, using a lowest nearest neighbour scalar quantization, ratio values within a specific selection to obtain quantization index values; calculating reconstructed values of the ratio parameters for the specific selection; calculating an error value based on the difference between the reconstructed ratio values and the specific selection of ratio parameter values; determining a sum of quantized index values; and selecting at least one quantized index value to increment such that the sum of quantized index values is equal to an expected index sum.

The means for selecting at least one quantized index value to increment such that the sum of quantized index values is equal to an expected index sum may be for one of: selecting the at least one quantized index value to increment based on identifying a greatest decrease within the error value when the index value is incremented; or selecting the at least one quantized index value to increment based on identifying a minimum increase within the error value when the index value is incremented.

The means for quantizing the selection of the ratio parameters may be for: determining for a specific selection of ratio parameters that the elements are zero; generating a further ratio parameter configured to identify a distribution of the object part of the total audio environment, the further ratio parameter value identifying that there is no object part contribution.

The means for encoding the remaining selection of the ratio parameters for the frame based on differential encoding of the selections based on the first set of selection of ratio parameters or a precedingly indexed time element or frequency element selection of ratio parameters may be for: performing with respect to a set of selection of ratio parameters with respect to a specific time element of the frame: determining a number of bits required for entropy coding the differences between the quantized frequency elements for a first and second entropy coding parameters; determining a number of bits required for entropy coding the differences between the quantized time elements for the first and second entropy coding parameters; selecting, for the specific time element, the first entropy coding parameter or the second entropy coding parameter based on a smaller number of bits required for coding the differences in the specific time element of the frame; selecting one of the entropy coding of the differences between frequency elements or time elements for the selected first entropy coding parameter or the second entropy coding parameter based entropy coding based on a smaller number of bits required for coding the differences in the specific time element of the frame.

The means for differential encoding of the selections based on the first set of selection of ratio parameters or a precedingly indexed time element or frequency element selection of ratio parameters may be for encoding the selected one of the entropy coding of the differences between frequency elements or time elements for the selected first entropy coding parameter or the second entropy coding parameter based entropy coding.

The means for encoding the remaining selection of the ratio parameters for the frame based on a differential encoding of the selection of ratio parameters based on the first set of selection of ratio parameters or a precedingly indexed time element or frequency element selection of ratio parameters may be for: performing with respect to a set of selection of ratio parameters with respect to a specific frequency element of the frame: determining a number of bits required entropy coding quantized differences between frequency elements for a first and second entropy coding parameters; determining a number of bits required entropy coding quantized differences between time elements for the first and second entropy coding parameters; selecting, for the specific frequency element, the first entropy coding parameter or the second entropy coding parameter based on a smaller number of bits required for coding the differences in the specific time element of the frame; selecting, for the specific frequency element, one of the entropy coding of differences between frequency elements or time elements for the selected first entropy coding parameter or the second entropy coding parameter based entropy coding based on a smaller number of bits required for coding the differences in the specific time element of the frame.

The means for differential encoding of the selections based on the first set of selection of ratio parameters or a precedingly indexed time element or frequency element selection of ratio parameters may be for encoding the selected one of the entropy coding of the differences between frequency elements or time elements for the selected first entropy coding parameter or the second entropy coding parameter based entropy coding.

The means for encoding the remaining selection of ratio parameters of the ratio parameters for the frame based on a differential encoding of the selection of ratio parameters based on the first set of selection of ratio parameters or a precedingly indexed time element or frequency element selection of ratio parameters may be for: generating an indicator indicating the selected first entropy coding parameter or the second entropy coding parameter; and generating an indicator indicating the selected one of the entropy coding of differences between frequency elements or time elements for the selected first entropy coding parameter or the second entropy coding parameter based entropy coding.

The entropy coding may be Golomb-Rice entropy coding and the first entropy coding parameter is a Golomb-Rice entropy coding order 0 and the second entropy coding parameter is a Golomb-Rice entropy coding order 1.

The means for encoding the remaining selection of ratio parameters of the ratio parameters for the frame based on the differential encoding of the selection of ratio parameters based on the first set of selection of ratio parameters or the precedingly indexed time element or frequency element selection of ratio parameters may be for differential encoding of the selection of ratio parameters based on the precedingly indexed time element selection of ratio parameters where there is no precedingly indexed frequency element selection of ratio parameters.

The ratio parameters configured to identify a distribution of a specific object within the object part of the total audio environment may be ISM ratios.

The further ratio parameter configured to identify a distribution of the object part of the total audio environment may be a MASA-to-total energy ratio.

According to a second aspect there is provided an apparatus for decoding an audio object parameter, the apparatus comprising means for: obtaining a bitstream comprising encoded ratio parameters, for time-frequency elements of a frame comprising more than one time element and more than one frequency element, the ratio parameters associated with audio object within an audio environment, the audio environment comprising more than one audio object and the ratio parameters configured to identify a distribution of a specific object within the object part of the total audio environment and for a specific time-frequency element; decoding a first set of a selection of ratio parameters based on an indexing of the selection; and decoding the remaining selection of the ratio parameters for the frame based on a differential decoding of the selection based on the first set of the selection of ratio parameters or a precedingly indexed time element or frequency element selection of the ratio parameters.

The selection may be a vector of the ratio parameters.

The means for decoding the first set of the selection of ratio parameters based on the indexing of the selection may be for: obtaining an integer value representing encoded ratio parameters; converting the integer value to a selection of ratio parameters based on the indexing of the vector; and regenerating at least one further ratio parameter from the selection of the ratio parameters.

The means for converting the integer value to the selection of ratio parameters based on the indexing of the vector may be for: generating a single number value by appending elements from the selection of ratio parameters; and generating the index from the single number, by performing an iteration loop from a zeroth iteration up to and including the single number of iterations and sequentially associating index values to iteration loop iteration numbers which have a valid selection of ratio parameters, wherein the integer value is the highest index value.

The means for decoding the remaining selection of the ratio parameters for the frame based on a differential decoding of the selection based on the first set of the selection of ratio parameters or a precedingly indexed time element or frequency element selection of the ratio parameters may be for: obtaining a difference indicator identifying a frequency difference or time difference encoding; obtaining an entropy encoding indicator identifying an entropy encoding parameter; decoding the remaining selection of the ratio parameters for the frame based on the difference indicator and the entropy encoding indicator.

The ratio parameters configured to identify a distribution of a specific object within the object part of the total audio environment may be ISM ratios. According to a third aspect there is provided a method for encoding an audio object parameter, the method comprising: obtaining, for time-frequency elements of a frame comprising more than one time element and more than one frequency element, a plurality of ratio parameters for an audio object within an audio environment, the audio environment comprising more than one audio object and the ratio parameters configured to identify a distribution of a specific object within the object part of the total audio environment and for a specific time-frequency element; quantizing selections of the ratio parameters, wherein the selections are associated with audio objects within a specific frame time-frequency element; encoding a first set of the selections of ratio parameters based on an indexing of the selections; and encoding the remaining selections of the ratio parameters for the frame based on a differential encoding of the selections based on the first set of selection of ratio parameters or a precedingly indexed time element or frequency element selection of ratio parameters.

The selections may be vectors of the ratio parameters and the method may further comprise generating the vectors of the ratio parameters representing the ratio parameters.

Encoding a first set of the selections of ratio parameters based on an indexing of the selections may comprise generating an integer value based on an indexing from the selection, wherein the generated integer value represents the ratio parameters for the audio objects.

Generating the integer value based on the indexing from the selection of ratio parameters may comprise: generating a single number value by appending elements from the selection of ratio parameters; and generating the index from the single number, by performing an iteration loop from a zeroth iteration up to and including the single number of iterations and sequentially associating index values to iteration loop iteration numbers which have a valid selection of ratio parameters, wherein the integer value is the highest index value.

Quantizing the selection of the ratio parameters may comprise: quantizing, using a lowest nearest neighbour scalar quantization, ratio values within a specific selection to obtain quantization index values; calculating reconstructed values of the ratio parameters for the specific selection; calculating an error value based on the difference between the reconstructed ratio values and the specific selection of ratio parameter values; determining a sum of quantized index values; and selecting at least one quantized index value to increment such that the sum of quantized index values is equal to an expected index sum.

Selecting at least one quantized index value to increment such that the sum of quantized index values is equal to an expected index sum may comprise one of: selecting the at least one quantized index value to increment based on identifying a greatest decrease within the error value when the index value is incremented; or selecting the at least one quantized index value to increment based on identifying a minimum increase within the error value when the index value is incremented.

Quantizing the selection of the ratio parameters may comprise: determining for a specific selection of ratio parameters that the elements are zero; generating a further ratio parameter configured to identify a distribution of the object part of the total audio environment, the further ratio parameter value identifying that there is no object part contribution.

Encoding the remaining selection of the ratio parameters for the frame based on differential encoding of the selections based on the first set of selection of ratio parameters or a precedingly indexed time element or frequency element selection of ratio parameters may comprise: performing with respect to a set of selection of ratio parameters with respect to a specific time element of the frame: determining a number of bits required for entropy coding the differences between the quantized frequency elements for a first and second entropy coding parameters; determining a number of bits required for entropy coding the differences between the quantized time elements for the first and second entropy coding parameters; selecting, for the specific time element, the first entropy coding parameter or the second entropy coding parameter based on a smaller number of bits required for coding the differences in the specific time element of the frame; selecting one of the entropy coding of the differences between frequency elements or time elements for the selected first entropy coding parameter or the second entropy coding parameter based entropy coding based on a smaller number of bits required for coding the differences in the specific time element of the frame.

Differential encoding of the selections based on the first set of selection of ratio parameters or a precedingly indexed time element or frequency element selection of ratio parameters may comprise encoding the selected one of the entropy coding of the differences between frequency elements or time elements for the selected first entropy coding parameter or the second entropy coding parameter based entropy coding.

Encoding the remaining selection of the ratio parameters for the frame based on a differential encoding of the selection of ratio parameters based on the first set of selection of ratio parameters or a precedingly indexed time element or frequency element selection of ratio parameters may comprise: performing with respect to a set of selection of ratio parameters with respect to a specific frequency element of the frame: determining a number of bits required entropy coding quantized differences between frequency elements for a first and second entropy coding parameters; determining a number of bits required entropy coding quantized differences between time elements for the first and second entropy coding parameters; selecting, for the specific frequency element, the first entropy coding parameter or the second entropy coding parameter based on a smaller number of bits required for coding the differences in the specific time element of the frame; selecting, for the specific frequency element, one of the entropy coding of differences between frequency elements or time elements for the selected first entropy coding parameter or the second entropy coding parameter based entropy coding based on a smaller number of bits required for coding the differences in the specific time element of the frame.

Differential encoding of the selections based on the first set of selection of ratio parameters or a precedingly indexed time element or frequency element selection of ratio parameters may comprise encoding the selected one of the entropy coding of the differences between frequency elements or time elements for the selected first entropy coding parameter or the second entropy coding parameter based entropy coding.

Encoding the remaining selection of ratio parameters of the ratio parameters for the frame based on a differential encoding of the selection of ratio parameters based on the first set of selection of ratio parameters or a precedingly indexed time element or frequency element selection of ratio parameters may comprise: generating an indicator indicating the selected first entropy coding parameter or the second entropy coding parameter; and generating an indicator indicating the selected one of the entropy coding of differences between frequency elements or time elements for the selected first entropy coding parameter or the second entropy coding parameter based entropy coding.

The entropy coding may be Golomb-Rice entropy coding and the first entropy coding parameter is a Golomb-Rice entropy coding order 0 and the second entropy coding parameter is a Golomb-Rice entropy coding order 1.

Encoding the remaining selection of ratio parameters of the ratio parameters for the frame based on the differential encoding of the selection of ratio parameters based on the first set of selection of ratio parameters or the precedingly indexed time element or frequency element selection of ratio parameters may comprise differential encoding of the selection of ratio parameters based on the precedingly indexed time element selection of ratio parameters where there is no precedingly indexed frequency element selection of ratio parameters.

The ratio parameters configured to identify a distribution of a specific object within the object part of the total audio environment may be ISM ratios.

The further ratio parameter configured to identify a distribution of the object part of the total audio environment may be a MASA-to-total energy ratio.

According to a fourth aspect there is provided a method for decoding an audio object parameter, the method comprising: obtaining a bitstream comprising encoded ratio parameters, for time-frequency elements of a frame comprising more than one time element and more than one frequency element, the ratio parameters associated with audio object within an audio environment, the audio environment comprising more than one audio object and the ratio parameters configured to identify a distribution of a specific object within the object part of the total audio environment and for a specific time-frequency element; decoding a first set of a selection of ratio parameters based on an indexing of the selection; and decoding the remaining selection of the ratio parameters for the frame based on a differential decoding of the selection based on the first set of the selection of ratio parameters or a precedingly indexed time element or frequency element selection of the ratio parameters.

The selection may be a vector of the ratio parameters.

Decoding the first set of the selection of ratio parameters based on the indexing of the selection may comprise: obtaining an integer value representing encoded ratio parameters; converting the integer value to a selection of ratio parameters based on the indexing of the vector; and regenerating at least one further ratio parameter from the selection of the ratio parameters.

Converting the integer value to the selection of ratio parameters based on the indexing of the vector may comprise: generating a single number value by appending elements from the selection of ratio parameters; and generating the index from the single number, by performing an iteration loop from a zeroth iteration up to and including the single number of iterations and sequentially associating index values to iteration loop iteration numbers which have a valid selection of ratio parameters, wherein the integer value is the highest index value.

Decoding the remaining selection of the ratio parameters for the frame based on a differential decoding of the selection based on the first set of the selection of ratio parameters or a precedingly indexed time element or frequency element selection of the ratio parameters may comprise: obtaining a difference indicator identifying a frequency difference or time difference encoding; obtaining an entropy encoding indicator identifying an entropy encoding parameter; decoding the remaining selection of the ratio parameters for the frame based on the difference indicator and the entropy encoding indicator.

The ratio parameters configured to identify a distribution of a specific object within the object part of the total audio environment may be ISM ratios.

According to a fifth aspect there is provided an apparatus for encoding an audio object parameter, the apparatus comprising at least one processor and at least one memory storing instructions that, when executed by the at least one processor, cause the system at least to perform: obtaining, for time-frequency elements of a frame comprising more than one time element and more than one frequency element, a plurality of ratio parameters for an audio object within an audio environment, the audio environment comprising more than one audio object and the ratio parameters configured to identify a distribution of a specific object within the object part of the total audio environment and for a specific time-frequency element; quantizing selections of the ratio parameters, wherein the selections are associated with audio objects within a specific frame time-frequency element; encoding a first set of the selections of ratio parameters based on an indexing of the selections; and encoding the remaining selections of the ratio parameters for the frame based on a differential encoding of the selections based on the first set of selection of ratio parameters or a precedingly indexed time element or frequency element selection of ratio parameters.

The selections may be vectors of the ratio parameters and the apparatus may be further caused to perform generating the vectors of the ratio parameters representing the ratio parameters.

The apparatus caused to perform encoding a first set of the selections of ratio parameters based on an indexing of the selections may be caused to perform generating an integer value based on an indexing from the selection, wherein the generated integer value represents the ratio parameters for the audio objects.

The apparatus caused to perform generating the integer value based on the indexing from the selection of ratio parameters may be caused to perform: generating a single number value by appending elements from the selection of ratio parameters; and generating the index from the single number, by performing an iteration loop from a zeroth iteration up to and including the single number of iterations and sequentially associating index values to iteration loop iteration numbers which have a valid selection of ratio parameters, wherein the integer value is the highest index value.

The apparatus caused to perform quantizing the selection of the ratio parameters may be caused to perform: quantizing, using a lowest nearest neighbour scalar quantization, ratio values within a specific selection to obtain quantization index values; calculating reconstructed values of the ratio parameters for the specific selection; calculating an error value based on the difference between the reconstructed ratio values and the specific selection of ratio parameter values; determining a sum of quantized index values; and selecting at least one quantized index value to increment such that the sum of quantized index values is equal to an expected index sum.

The apparatus caused to perform selecting at least one quantized index value to increment such that the sum of quantized index values is equal to an expected index sum may be caused to perform one of: selecting the at least one quantized index value to increment based on identifying a greatest decrease within the error value when the index value is incremented; or selecting the at least one quantized index value to increment based on identifying a minimum increase within the error value when the index value is incremented.

The apparatus caused to perform quantizing the selection of the ratio parameters may be caused to perform: determining for a specific selection of ratio parameters that the elements are zero; generating a further ratio parameter configured to identify a distribution of the object part of the total audio environment, the further ratio parameter value identifying that there is no object part contribution.

The apparatus caused to perform encoding the remaining selection of the ratio parameters for the frame based on differential encoding of the selections based on the first set of selection of ratio parameters or a precedingly indexed time element or frequency element selection of ratio parameters may be caused to perform: with respect to a set of selection of ratio parameters with respect to a specific time element of the frame: determining a number of bits required for entropy coding the differences between the quantized frequency elements for a first and second entropy coding parameters; determining a number of bits required for entropy coding the differences between the quantized time elements for the first and second entropy coding parameters; selecting, for the specific time element, the first entropy coding parameter or the second entropy coding parameter based on a smaller number of bits required for coding the differences in the specific time element of the frame; selecting one of the entropy coding of the differences between frequency elements or time elements for the selected first entropy coding parameter or the second entropy coding parameter based entropy coding based on a smaller number of bits required for coding the differences in the specific time element of the frame.

The apparatus caused to perform differential encoding of the selections based on the first set of selection of ratio parameters or a precedingly indexed time element or frequency element selection of ratio parameters may be caused to perform encoding the selected one of the entropy coding of the differences between frequency elements or time elements for the selected first entropy coding parameter or the second entropy coding parameter based entropy coding.

The apparatus caused to perform encoding the remaining selection of the ratio parameters for the frame based on a differential encoding of the selection of ratio parameters based on the first set of selection of ratio parameters or a precedingly indexed time element or frequency element selection of ratio parameters may be caused to: performing with respect to a set of selection of ratio parameters with respect to a specific frequency element of the frame: determining a number of bits required entropy coding quantized differences between frequency elements for a first and second entropy coding parameters; determining a number of bits required entropy coding quantized differences between time elements for the first and second entropy coding parameters; selecting, for the specific frequency element, the first entropy coding parameter or the second entropy coding parameter based on a smaller number of bits required for coding the differences in the specific time element of the frame; selecting, for the specific frequency element, one of the entropy coding of differences between frequency elements or time elements for the selected first entropy coding parameter or the second entropy coding parameter based entropy coding based on a smaller number of bits required for coding the differences in the specific time element of the frame.

The apparatus caused to perform differential encoding of the selections based on the first set of selection of ratio parameters or a precedingly indexed time element or frequency element selection of ratio parameters may be caused to perform encoding the selected one of the entropy coding of the differences between frequency elements or time elements for the selected first entropy coding parameter or the second entropy coding parameter based entropy coding.

The apparatus caused to perform encoding the remaining selection of ratio parameters of the ratio parameters for the frame based on a differential encoding of the selection of ratio parameters based on the first set of selection of ratio parameters or a precedingly indexed time element or frequency element selection of ratio parameters may be caused to perform: generating an indicator indicating the selected first entropy coding parameter or the second entropy coding parameter; and generating an indicator indicating the selected one of the entropy coding of differences between frequency elements or time elements for the selected first entropy coding parameter or the second entropy coding parameter based entropy coding.

The entropy coding may be Golomb-Rice entropy coding and the first entropy coding parameter is a Golomb-Rice entropy coding order 0 and the second entropy coding parameter is a Golomb-Rice entropy coding order 1.

The apparatus caused to perform encoding the remaining selection of ratio parameters of the ratio parameters for the frame based on the differential encoding of the selection of ratio parameters based on the first set of selection of ratio parameters or the precedingly indexed time element or frequency element selection of ratio parameters may be caused to perform differential encoding of the selection of ratio parameters based on the precedingly indexed time element selection of ratio parameters where there is no precedingly indexed frequency element selection of ratio parameters.

The ratio parameters configured to identify a distribution of a specific object within the object part of the total audio environment may be ISM ratios.

The further ratio parameter configured to identify a distribution of the object part of the total audio environment may be a MASA-to-total energy ratio.

According to a sixth aspect there is provided an apparatus for decoding an audio object parameter, the apparatus comprising at least one processor and at least one memory storing instructions that, when executed by the at least one processor, cause the system at least to perform: obtaining a bitstream comprising encoded ratio parameters, for time-frequency elements of a frame comprising more than one time element and more than one frequency element, the ratio parameters associated with audio object within an audio environment, the audio environment comprising more than one audio object and the ratio parameters configured to identify a distribution of a specific object within the object part of the total audio environment and for a specific time-frequency element; decoding a first set of a selection of ratio parameters based on an indexing of the selection; and decoding the remaining selection of the ratio parameters for the frame based on a differential decoding of the selection based on the first set of the selection of ratio parameters or a precedingly indexed time element or frequency element selection of the ratio parameters.

The selection may be a vector of the ratio parameters.

The apparatus caused to perform decoding the first set of the selection of ratio parameters based on the indexing of the selection may be caused to perform: obtaining an integer value representing encoded ratio parameters; converting the integer value to a selection of ratio parameters based on the indexing of the vector; and regenerating at least one further ratio parameter from the selection of the ratio parameters.

The apparatus caused to perform converting the integer value to the selection of ratio parameters based on the indexing of the vector may be caused ot perform: generating a single number value by appending elements from the selection of ratio parameters; and generating the index from the single number, by performing an iteration loop from a zeroth iteration up to and including the single number of iterations and sequentially associating index values to iteration loop iteration numbers which have a valid selection of ratio parameters, wherein the integer value is the highest index value.

The apparatus caused to perform decoding the remaining selection of the ratio parameters for the frame based on a differential decoding of the selection based on the first set of the selection of ratio parameters or a precedingly indexed time element or frequency element selection of the ratio parameters may be caused to perform: obtaining a difference indicator identifying a frequency difference or time difference encoding; obtaining an entropy encoding indicator identifying an entropy encoding parameter; decoding the remaining selection of the ratio parameters for the frame based on the difference indicator and the entropy encoding indicator.

The ratio parameters configured to identify a distribution of a specific object within the object part of the total audio environment may be ISM ratios.

According to a seventh aspect there is provided an apparatus for encoding an audio object parameter, the apparatus comprising: obtaining circuitry configured to obtain, for time-frequency elements of a frame comprising more than one time element and more than one frequency element, a plurality of ratio parameters for an audio object within an audio environment, the audio environment comprising more than one audio object and the ratio parameters configured to identify a distribution of a specific object within the object part of the total audio environment and for a specific time-frequency element; quantizing circuitry configured to quantize selections of the ratio parameters, wherein the selections are associated with audio objects within a specific frame time-frequency element; encoding circuitry configured to encode a first set of the selections of ratio parameters based on an indexing of the selections; and encoding circuitry configured to encode the remaining selections of the ratio parameters for the frame based on a differential encoding of the selections based on the first set of selection of ratio parameters or a precedingly indexed time element or frequency element selection of ratio parameters.

According to an eighth aspect there is provided an apparatus for decoding an audio object parameter, the apparatus comprising: obtaining circuitry configured to obtain a bitstream comprising encoded ratio parameters, for time-frequency elements of a frame comprising more than one time element and more than one frequency element, the ratio parameters associated with audio object within an audio environment, the audio environment comprising more than one audio object and the ratio parameters configured to identify a distribution of a specific object within the object part of the total audio environment and for a specific time-frequency element; decoding circuitry configured to decode a first set of a selection of ratio parameters based on an indexing of the selection; and decoding circuitry configured to decode the remaining selection of the ratio parameters for the frame based on a differential decoding of the selection based on the first set of the selection of ratio parameters or a precedingly indexed time element or frequency element selection of the ratio parameters.

According to a nineth aspect there is provided a computer program comprising instructions [or a computer readable medium comprising program instructions] for causing an apparatus for encoding an audio object parameter to perform at least the following: obtaining, for time-frequency elements of a frame comprising more than one time element and more than one frequency element, a plurality of ratio parameters for an audio object within an audio environment, the audio environment comprising more than one audio object and the ratio parameters configured to identify a distribution of a specific object within the object part of the total audio environment and for a specific time-frequency element; quantizing selections of the ratio parameters, wherein the selections are associated with audio objects within a specific frame time-frequency element; encoding a first set of the selections of ratio parameters based on an indexing of the selections; and encoding the remaining selections of the ratio parameters for the frame based on a differential encoding of the selections based on the first set of selection of ratio parameters or a precedingly indexed time element or frequency element selection of ratio parameters.

According to a tenth aspect there is provided a computer program comprising instructions [or a computer readable medium comprising program instructions] for causing an apparatus for decoding an audio object parameter to perform at least the following: obtaining a bitstream comprising encoded ratio parameters, for time-frequency elements of a frame comprising more than one time element and more than one frequency element, the ratio parameters associated with audio object within an audio environment, the audio environment comprising more than one audio object and the ratio parameters configured to identify a distribution of a specific object within the object part of the total audio environment and for a specific time-frequency element; decoding a first set of a selection of ratio parameters based on an indexing of the selection; and decoding the remaining selection of the ratio parameters for the frame based on a differential decoding of the selection based on the first set of the selection of ratio parameters or a precedingly indexed time element or frequency element selection of the ratio parameters.

According to an eleventh aspect there is provided a non-transitory computer readable medium comprising program instructions for causing an apparatus for encoding an audio object parameter to perform at least the following: obtaining, for time-frequency elements of a frame comprising more than one time element and more than one frequency element, a plurality of ratio parameters for an audio object within an audio environment, the audio environment comprising more than one audio object and the ratio parameters configured to identify a distribution of a specific object within the object part of the total audio environment and for a specific time-frequency element; quantizing selections of the ratio parameters, wherein the selections are associated with audio objects within a specific frame time-frequency element; encoding a first set of the selections of ratio parameters based on an indexing of the selections; and encoding the remaining selections of the ratio parameters for the frame based on a differential encoding of the selections based on the first set of selection of ratio parameters or a precedingly indexed time element or frequency element selection of ratio parameters.

According to a twelfth aspect there is provided a non-transitory computer readable medium comprising program instructions for causing an apparatus for decoding an audio object parameter to perform at least the following: obtaining a bitstream comprising encoded ratio parameters, for time-frequency elements of a frame comprising more than one time element and more than one frequency element, the ratio parameters associated with audio object within an audio environment, the audio environment comprising more than one audio object and the ratio parameters configured to identify a distribution of a specific object within the object part of the total audio environment and for a specific time-frequency element; decoding a first set of a selection of ratio parameters based on an indexing of the selection; and decoding the remaining selection of the ratio parameters for the frame based on a differential decoding of the selection based on the first set of the selection of ratio parameters or a precedingly indexed time element or frequency element selection of the ratio parameters.

According to a thirteenth aspect there is provided an apparatus for encoding an audio object parameter, the apparatus comprising: means for obtaining for time-frequency elements of a frame comprising more than one time element and more than one frequency element, a plurality of ratio parameters for an audio object within an audio environment, the audio environment comprising more than one audio object and the ratio parameters configured to identify a distribution of a specific object within the object part of the total audio environment and for a specific time-frequency element; means for quantizing selections of the ratio parameters, wherein the selections are associated with audio objects within a specific frame time-frequency element; means for encoding a first set of the selections of ratio parameters based on an indexing of the selections; and means for encoding the remaining selections of the ratio parameters for the frame based on a differential encoding of the selections based on the first set of selection of ratio parameters or a precedingly indexed time element or frequency element selection of ratio parameters.

According to a fourteenth aspect there is provided an apparatus for decoding an audio object parameter, the apparatus comprising: means for obtaining a bitstream comprising encoded ratio parameters, for time-frequency elements of a frame comprising more than one time element and more than one frequency element, the ratio parameters associated with audio object within an audio environment, the audio environment comprising more than one audio object and the ratio parameters configured to identify a distribution of a specific object within the object part of the total audio environment and for a specific time-frequency element; means for decoding a first set of a selection of ratio parameters based on an indexing of the selection; and means for decoding the remaining selection of the ratio parameters for the frame based on a differential decoding of the selection based on the first set of the selection of ratio parameters or a precedingly indexed time element or frequency element selection of the ratio parameters.

According to a fifteenth aspect there is provided a computer readable medium comprising program instructions for causing an apparatus for encoding an audio object parameter to perform at least the following: obtaining, for time-frequency elements of a frame comprising more than one time element and more than one frequency element, a plurality of ratio parameters for an audio object within an audio environment, the audio environment comprising more than one audio object and the ratio parameters configured to identify a distribution of a specific object within the object part of the total audio environment and for a specific time-frequency element; quantizing selections of the ratio parameters, wherein the selections are associated with audio objects within a specific frame time-frequency element; encoding a first set of the selections of ratio parameters based on an indexing of the selections; and encoding the remaining selections of the ratio parameters for the frame based on a differential encoding of the selections based on the first set of selection of ratio parameters or a precedingly indexed time element or frequency element selection of ratio parameters.

According to a sixteenth aspect there is provided a computer readable medium comprising program instructions for causing an apparatus for decoding an audio object parameter to perform at least the following: obtaining a bitstream comprising encoded ratio parameters, for time-frequency elements of a frame comprising more than one time element and more than one frequency element, the ratio parameters associated with audio object within an audio environment, the audio environment comprising more than one audio object and the ratio parameters configured to identify a distribution of a specific object within the object part of the total audio environment and for a specific time-frequency element; decoding a first set of a selection of ratio parameters based on an indexing of the selection; and decoding the remaining selection of the ratio parameters for the frame based on a differential decoding of the selection based on the first set of the selection of ratio parameters or a precedingly indexed time element or frequency element selection of the ratio parameters.

According to a seventeenth aspect there is provided an apparatus for encoding audio signals, the apparatus comprising means for: obtaining a plurality of audio object audio signals; obtaining a spatial audio signal; determining an available bitrate for encoding the plurality of audio object audio signals and the spatial audio signal; selecting an encoding mode based on the available bitrate; and encoding the plurality of audio object audio signals and the spatial audio signal based on the encoding mode.

The encoding mode may comprise a first encoding mode wherein at least one transport audio signal and associated spatial audio signal metadata are encoded.

The first encoding mode may be selected when the available bitrate is below a first bitrate threshold.

The means may be further for generating the at least one transport audio signal by combining the plurality of audio object audio signals and at least one audio signal from the spatial audio signal.

The encoding mode may comprise a second encoding mode wherein at least one transport audio signal, associated spatial audio metadata, associated audio object metadata, ratio parameters configured to identify a distribution of a specific audio object within an audio object part of a total audio environment, and a further ratio parameter configured to identify a distribution of the audio object part of the total audio environment are encoded.

The second encoding mode may be selected when the available bitrate is below a second bitrate threshold, the second bitrate threshold being greater than the first bitrate threshold.

The means may be further for generating the at least one transport audio signal by combining the plurality of audio object audio signals and at least one audio signal from the spatial audio signal.

The encoding mode may comprise a third encoding mode wherein at least one transport audio signal, a selected single audio object audio signal, associated spatial audio metadata, associated audio object metadata, an object identifier for identifying the selected single audio object audio signal from the plurality of audio object audio signals; ratio parameters configured to identify a distribution of a specific audio object within an object part of a total audio environment, and a further ratio parameter configured to identify a distribution of the object part of the total audio environment are encoded.

The third encoding mode may be selected when the available bitrate is below a third bitrate threshold, the third bitrate threshold being greater than the second bitrate threshold.

The means may be further for: selecting one of the plurality of audio objects; generating the selected single object audio signal based on an audio object audio signal from the selected one of the plurality of audio objects; generating the at least one transport audio signal by combining the remaining of the plurality of audio object audio signals and spatial audio signal.

The means may be further for analysing the audio object audio signals and spatial audio signal to determine the ratio parameters configured to identify the distribution of the specific audio object within the object part of the total audio environment.

The means may be further for analysing the audio object audio signals and spatial audio signal to determine the further ratio parameter configured to identify the distribution of the object part of the total audio environment,

The encoding mode may comprise a fourth encoding mode wherein the plurality of audio object audio signals, a transport audio signal based on the spatial audio signal, associated spatial audio metadata, associated object metadata are separately encoded.

The fourth encoding mode may be selected when the available bitrate is above the third bitrate threshold.

The spatial audio signal may comprise one of: a multichannel audio signal; a MASA audio signal; a single channel audio signal; a stereo audio signal; and a parametric spatial audio signal.

The spatial audio signal may comprise associated spatial audio metadata, wherein the spatial audio metadata may comprise at least one of: a directional parameter; an energy ratio parameter; a surround coherence parameter; a spread coherence parameter; a number of directions; and a distance parameter.

According to an eighteenth aspect there is provided a method for encoding audio signals, the method comprising: obtaining a plurality of audio object audio signals; obtaining a spatial audio signal; determining an available bitrate for encoding the plurality of audio object audio signals and the spatial audio signal; selecting an encoding mode based on the available bitrate; and encoding the plurality of audio object audio signals and the spatial audio signal based on the encoding mode.

The encoding mode may comprise a first encoding mode wherein at least one transport audio signal and associated spatial audio signal metadata are encoded.

The first encoding mode may be selected when the available bitrate is below a first bitrate threshold.

The method may further comprise generating the at least one transport audio signal by combining the plurality of audio object audio signals and at least one audio signal from the spatial audio signal.

The encoding mode may comprise a second encoding mode wherein at least one transport audio signal, associated spatial audio metadata, associated audio object metadata, ratio parameters configured to identify a distribution of a specific audio object within an audio object part of a total audio environment, and a further ratio parameter configured to identify a distribution of the audio object part of the total audio environment are encoded.

The second encoding mode may be selected when the available bitrate is below a second bitrate threshold, the second bitrate threshold being greater than the first bitrate threshold.

The method may further comprise generating the at least one transport audio signal by combining the plurality of audio object audio signals and at least one audio signal from the spatial audio signal.

The encoding mode may comprise a third encoding mode wherein at least one transport audio signal, a selected single audio object audio signal, associated spatial audio metadata, associated audio object metadata, an object identifier for identifying the selected single audio object audio signal from the plurality of audio object audio signals; ratio parameters configured to identify a distribution of a specific audio object within an object part of a total audio environment, and a further ratio parameter configured to identify a distribution of the object part of the total audio environment are encoded.

The third encoding mode may be selected when the available bitrate is below a third bitrate threshold, the third bitrate threshold being greater than the second bitrate threshold.

The method may further comprise: selecting one of the plurality of audio objects; generating the selected single object audio signal based on an audio object audio signal from the selected one of the plurality of audio objects; generating the at least one transport audio signal by combining the remaining of the plurality of audio object audio signals and spatial audio signal.

The method may further comprise analysing the audio object audio signals and spatial audio signal to determine the ratio parameters configured to identify the distribution of the specific audio object within the object part of the total audio environment.

The method may further comprise analysing the audio object audio signals and spatial audio signal to determine the further ratio parameter configured to identify the distribution of the object part of the total audio environment,

The encoding mode may comprise a fourth encoding mode wherein the plurality of audio object audio signals, a transport audio signal based on the spatial audio signal, associated spatial audio metadata, associated object metadata are separately encoded.

The fourth encoding mode may be selected when the available bitrate is above the third bitrate threshold.

The spatial audio signal may comprise one of: a multichannel audio signal; a MASA audio signal; a single channel audio signal; a stereo audio signal; and a parametric spatial audio signal.

The spatial audio signal may comprise associated spatial audio metadata, wherein the spatial audio metadata may comprise at least one of: a directional parameter; an energy ratio parameter; a surround coherence parameter; a spread coherence parameter; a number of directions; and a distance parameter.

According to a nineteenth aspect there is provided an apparatus, for encoding audio signals, the apparatus comprising at least one processor and at least one memory storing instructions that, when executed by the at least one processor, cause the system at least to perform: obtaining a plurality of audio object audio signals; obtaining a spatial audio signal; determining an available bitrate for encoding the plurality of audio object audio signals and the spatial audio signal; selecting an encoding mode based on the available bitrate; and encoding the plurality of audio object audio signals and the spatial audio signal based on the encoding mode.

The encoding mode may comprise a first encoding mode wherein at least one transport audio signal and associated spatial audio signal metadata are encoded.

The first encoding mode may be selected when the available bitrate is below a first bitrate threshold.

The apparatus may further be caused to perform generating the at least one transport audio signal by combining the plurality of audio object audio signals and at least one audio signal from the spatial audio signal.

The encoding mode may comprise a second encoding mode wherein at least one transport audio signal, associated spatial audio metadata, associated audio object metadata, ratio parameters configured to identify a distribution of a specific audio object within an audio object part of a total audio environment, and a further ratio parameter configured to identify a distribution of the audio object part of the total audio environment are encoded.

The second encoding mode may be selected when the available bitrate is below a second bitrate threshold, the second bitrate threshold being greater than the first bitrate threshold.

The apparatus may further be caused to perform generating the at least one transport audio signal by combining the plurality of audio object audio signals and at least one audio signal from the spatial audio signal.

The encoding mode may comprise a third encoding mode wherein at least one transport audio signal, a selected single audio object audio signal, associated spatial audio metadata, associated audio object metadata, an object identifier for identifying the selected single audio object audio signal from the plurality of audio object audio signals; ratio parameters configured to identify a distribution of a specific audio object within an object part of a total audio environment, and a further ratio parameter configured to identify a distribution of the object part of the total audio environment are encoded.

The third encoding mode may be selected when the available bitrate is below a third bitrate threshold, the third bitrate threshold being greater than the second bitrate threshold.

The apparatus may further be caused to perform: selecting one of the plurality of audio objects; generating the selected single object audio signal based on an audio object audio signal from the selected one of the plurality of audio objects; generating the at least one transport audio signal by combining the remaining of the plurality of audio object audio signals and spatial audio signal.

The apparatus may further be caused to perform analysing the audio object audio signals and spatial audio signal to determine the ratio parameters configured to identify the distribution of the specific audio object within the object part of the total audio environment.

The apparatus may further be caused to perform analysing the audio object audio signals and spatial audio signal to determine the further ratio parameter configured to identify the distribution of the object part of the total audio environment,

The encoding mode may comprise a fourth encoding mode wherein the plurality of audio object audio signals, a transport audio signal based on the spatial audio signal, associated spatial audio metadata, associated object metadata are separately encoded.

The fourth encoding mode may be selected when the available bitrate is above the third bitrate threshold.

The spatial audio signal may comprise one of: a multichannel audio signal; a MASA audio signal; a single channel audio signal; a stereo audio signal; and a parametric spatial audio signal.

The spatial audio signal may comprise associated spatial audio metadata, wherein the spatial audio metadata may comprise at least one of: a directional parameter; an energy ratio parameter; a surround coherence parameter; a spread coherence parameter; a number of directions; and a distance parameter. According to a twentieth aspect there is provided an apparatus for encoding audio signals; the apparatus comprising: means for obtaining a plurality of audio object audio signals; means for obtaining a spatial audio signal; means for determining an available bitrate for encoding the plurality of audio object audio signals and the spatial audio signal; means for selecting an encoding mode based on the available bitrate; and means for encoding the plurality of audio object audio signals and the spatial audio signal based on the encoding mode.

According to a twenty-first aspect there is provided an apparatus for encoding audio signals, the apparatus comprising: obtaining circuitry configured to obtain a plurality of audio object audio signals; obtaining circuitry configured to obtain a spatial audio signal; determining circuitry configured to determine an available bitrate for encoding the plurality of audio object audio signals and the spatial audio signal; selecting circuitry configured to select an encoding mode based on the available bitrate; and encoding circuitry configured to encode the plurality of audio object audio signals and the spatial audio signal based on the encoding mode.

According to a twenty-second aspect there is provided a computer program comprising instructions [or a computer readable medium comprising instructions] for causing an apparatus for encoding audio signals, the apparatus caused to perform at least the following: obtaining a plurality of audio object audio signals; obtaining a spatial audio signal; determining an available bitrate for encoding the plurality of audio object audio signals and the spatial audio signal; selecting an encoding mode based on the available bitrate; and encoding the plurality of audio object audio signals and the spatial audio signal based on the encoding mode.

According to a twenty-third aspect there is provided a non-transitory computer readable medium comprising program instructions for causing an apparatus for encoding audio signals, the apparatus caused to perform at least the following: obtaining a plurality of audio object audio signals; obtaining a spatial audio signal; determining an available bitrate for encoding the plurality of audio object audio signals and the spatial audio signal; selecting an encoding mode based on the available bitrate; and encoding the plurality of audio object audio signals and the spatial audio signal based on the encoding mode.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a system of apparatus suitable for implementing some embodiments;

FIG. 2 shows schematically an example encoding mode selector as shown in the system of apparatus as shown in FIG. 1 according to some embodiments;

FIG. 3 shows a flow diagram of the operation of the example encoding mode selector shown in FIG. 2 according to some embodiments;

FIG. 4 shows a flow diagram of the operation of the example first, lowest, or only MASA bitrate encoding mode shown in FIG. 4 according to some embodiments;

FIG. 5 shows a flow diagram of the operation of the example second, lower, or object information encoding mode shown in FIG. 4 according to some embodiments;

FIG. 6 shows a flow diagram of the operation of the example third, higher, or single object encoding mode shown in FIG. 4 according to some embodiments;

FIG. 7 shows a flow diagram of the operation of the example fourth, highest, or independent object and multi-input encoding mode shown in FIG. 4 according to some embodiments;

FIG. 8 shows schematically an example audio object analyser and audio object metadata encoder as shown in FIG. 1 with respect to the fourth encoding mode according to some embodiments;

FIG. 9 shows a flow diagram of the operation of the example audio object analyser and audio object metadata encoder encoding mode selector shown in FIG. 8 according to some embodiments;

FIG. 10 shows a flow diagram of the operation of the example ISM ratio quantization optimizer shown in FIG. 8 according to some embodiments;

FIG. 11 shows schematically an example ISM vector index generator as shown in FIG. 8 according to some embodiments;

FIG. 12 shows a flow diagram of the operation of the example ISM vector index generator as shown in FIG. 11 according to some embodiments;

FIG. 13 shows an example device suitable for implementing the apparatus shown in previous figures.

### EMBODIMENTS OF THE APPLICATION

The following describes in further detail suitable apparatus and possible mechanisms for the encoding of parametric spatial audio signals comprising transport audio signals and spatial metadata. As indicated above immersive audio codecs (such as 3GPP IVAS) are being planned which support a multitude of operating points ranging from a low bit rate operation to transparency. It is expected to support channel-based audio and scene-based audio inputs including spatial information about the sound field and sound sources. In the following the example codec is configured to be able to receive multiple input formats. In particular the codec is configured to obtain or receive a multi audio signal (for example received from a microphone array, or as a multichannel audio format input, or an ambisonics format input) and an audio object signal (these can also be called an independent stream with metadata-ISM format). Furthermore in some situations the codec is configured to handle more than one input format at a time. This combined (input) format mode can, for example, enable simultaneous encoding of two different audio input formats. An example of two different audio input formats being currently considered is the combination of the MASA format with audio object format. Metadata-Assisted Spatial Audio (MASA) is an example of a parametric spatial audio format and representation suitable as an input format for IVAS.

It can be considered an audio representation consisting of ‘N channels+spatial metadata’. It is a scene-based audio format particularly suited for spatial audio capture on practical devices, such as smartphones. The idea is to describe the sound scene in terms of time- and frequency-varying sound source directions and, e.g., energy ratios. Sound energy that is not defined (described) by the directions, is described as diffuse (coming from all directions).

As discussed above spatial metadata associated with the audio signals may comprise multiple parameters (such as multiple directions and associated with each direction (or directional value) a direct-to-total energy ratio, spread coherence, distance, etc.) per time-frequency tile. The spatial metadata may also comprise other parameters or may be associated with other parameters which are considered to be non-directional (such as surround coherence, diffuse-to-total energy ratio, remainder-to-total energy ratio) but when combined with the directional parameters are able to be used to define the characteristics of the audio scene. For example a reasonable design choice which is able to produce a good quality output is one where the spatial metadata comprises one or more directions for each time-frequency subframe (and associated with each direction direct-to-total ratios, spread coherence, distance values etc) are determined.

The concept as discussed in further detail herein is the definition of a multi-rate coding model which provides for encoding of a combined format at various bitrates. This coding model enables a parametric encoding of the audio object input that includes encoding a ISM energy ratio parameter configured to define the fraction of the audio scene created by each object within the audio scene created by all the objects.

In the following examples, for each time-frequency tile, there is shown a group of 0 such ISM energy ratio parameters values, where 0 is the number of objects in the scene. As there can be a significant number of such values within a frame (e.g., 20×0), the efficient encoding of the values as provided by the embodiments herein can produce significant bandwidth and bitrate savings.

As described above, parametric spatial metadata representation can use multiple concurrent spatial directions. With MASA, the proposed maximum number of concurrent directions is two. For each concurrent direction, there may be associated parameters such as: Direction index; Direct-to-total ratio; Spread coherence; and Distance. In some embodiments other parameters such as Diffuse-to-total energy ratio; Surround coherence; and Remainder-to-total energy ratio are defined.

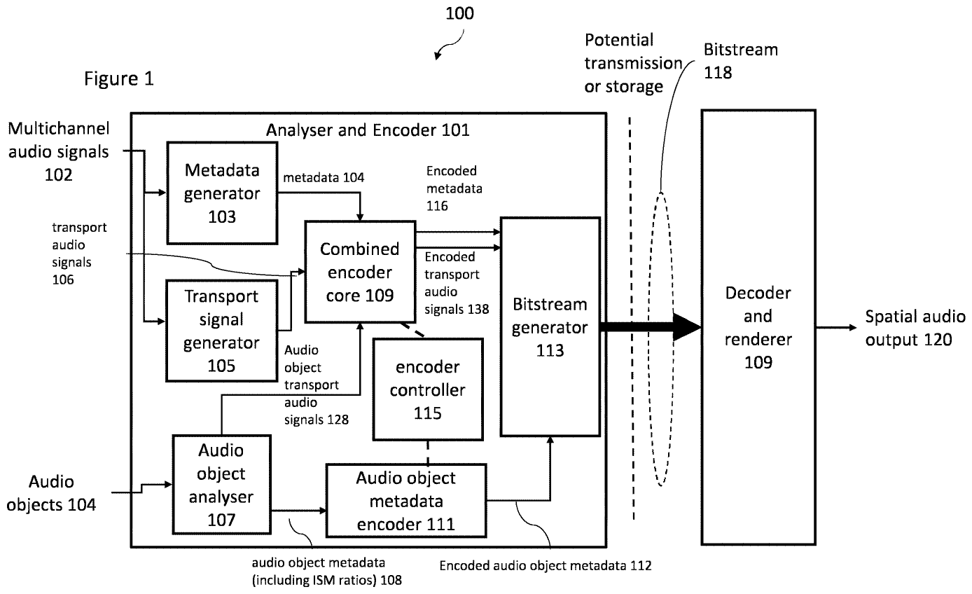

In this regard FIG. 1 depicts an example apparatus 100 and system for implementing embodiments of the application. The system is shown with an ‘analysis’ part. The ‘analysis’ part is the part from receiving the multichannel signals up to an encoding of the metadata and downmix signal.

The input to the system ‘analysis’ part is the multichannel audio signals 102. In the following examples a microphone channel signal input is described, however any suitable input (or synthetic multichannel) format may be implemented in other embodiments. For example, in some embodiments the spatial analyser and the spatial analysis may be implemented external to the encoder. For example, in some embodiments the spatial (MASA) metadata associated with the audio signals may be provided to an encoder as a separate bit-stream. In some embodiments the spatial (MASA) metadata may be provided as a set of spatial (direction) index values.

Additionally, FIG. 1 also depicts multiple audio objects 104 as a further input to the analysis part. As mentioned above these multiple audio objects (or audio object stream) 104 may represent various sound sources within a physical space. Each audio object may be characterized by an audio (object) signal and accompanying metadata comprising directional data (in the form of azimuth and elevation values) which indicate the position or direction of the audio object within a physical space on an audio frame basis.

The multichannel signals 102 are passed to an analyser and encoder 101, and specifically a transport signal generator 105 and to a metadata generator 103.

In some embodiments the metadata generator 103 is also configured to receive the multichannel signals and analyse the signals to produce metadata 104 associated with the multichannel signals and thus associated with the transport signals 106. The analysis processor 103 may be configured to generate the metadata which may comprise, for each time-frequency analysis interval, a direction parameter and an energy ratio parameter and a coherence parameter (and in some embodiments a diffuseness parameter). The direction, energy ratio and coherence parameters may in some embodiments be considered to be MASA spatial audio parameters (or MASA metadata). In other words, the spatial audio parameters comprise parameters which aim to characterize the sound-field created/captured by the multichannel signals (or two or more audio signals in general).

In some embodiments the parameters generated may differ from frequency band to frequency band. Thus, for example in band X all of the parameters are generated and transmitted, whereas in band Y only one of the parameters is generated and transmitted, and furthermore in band Z no parameters are generated or transmitted. A practical example of this may be that for some frequency bands such as the highest band some of the parameters are not required for perceptual reasons. The transport signals 106 and the metadata 104 may be passed to a combined encoder core 109.

In some embodiments the transport signal generator 105 is configured to receive the multichannel signals and generate a suitable transport signal comprising a determined number of channels and output the transport signals 106 (MASA transport audio signals). For example, the transport signal generator 105 may be configured to generate a 2-audio channel downmix of the multichannel signals. The determined number of channels may be any suitable number of channels. The transport signal generator in some embodiments is configured to otherwise select or combine, for example, by beamforming techniques the input audio signals to the determined number of channels and output these as transport signals.

In some embodiments the transport signal generator 105 is optional and the multichannel signals are passed unprocessed to a combined encoder core 109 in the same manner as the transport signal are in this example.

The audio objects 104 may be passed to the audio object analyser 107 for processing. In some embodiments the audio object analyser 107 analyses the object audio input stream 104 in order to produce suitable audio object transport signals and audio object metadata. For example, the audio object analyser may be configured to produce the audio object transport signals by downmixing the audio signals of the audio objects into a stereo channel together using amplitude panning based on the associated audio object directions. Additionally, the audio object analyser may also be configured to produce the audio object metadata associated with the audio object input stream 104. The audio object metadata may comprise direction values which are applicable for all sub-bands. So, if there are 4 objects, there are 4 directions. In the examples described herein the direction values also apply across all of the subframes of the frame, but in some embodiments the temporal resolution of the direction values can differ and the directions values apply for one or more than one sub-frames of the frame. Furthermore, energy ratios (or ISM ratios) may be determined for each object. The energy ratio (ISM ratio) defines the contribution of the object within the object part of the total audio environment. In the following examples the energy ratios (or ISM ratios), are for each time-frequency tile for each object.

In some embodiments, the audio object analyser 107 may be sited elsewhere and the audio objects 104 input to the analyser and encoder 101 is audio object transport signals and audio object metadata.

The analyser and encoder 101 may comprise a combined encoder core 109 which is configured to receive the transport audio (for example downmix) signals 106 and audio object transport signals 128 in order to generate a suitable encoding of these audio signals.

The analyser and encoder 101 may also comprise an audio object metadata encoder 111 which is similarly configured to receive the audio object metadata 108 and output an encoded or compressed form of the input information as encoded audio object metadata 112.

In some embodiments the combined encoder core 109 can be configured to implement a stream separation metadata determiner and encoder which can be configured to determine the relative contributory proportions of the multichannel signals 102 (which can be also known as MASA audio signals) and audio objects 104 to the overall audio scene. The following examples describe the combination of the multichannel audio signals and audio objects but in some embodiments the multichannel audio signals can be generalised as spatial audio signals. This measure of proportionality produced by the stream separation metadata determiner and encoder may be used to determine the proportion of quantizing and encoding “effort” expended for the input multichannel signals 102 and the audio objects 104. In other words, the stream separation metadata determiner and encoder may produce a metric which quantifies the proportion of the encoding effort expended on the multichannel audio signals 102 compared to the encoding effort expended on the audio objects 104. This metric may be used to drive the encoding of the audio object metadata 108 and the metadata 104. Furthermore, the metric as determined by the separation metadata determiner and encoder may also be used as an influencing factor in the process of encoding the transport audio signals 106 and audio object transport audio signal 128 performed by the combined encoder core 109. The output metric from the stream separation metadata determiner and encoder can furthermore be represented as encoded stream separation metadata and be combined into the encoded metadata stream from the combined encoder core 109.

In some embodiments the analyser and encoder 101 comprises a bitstream generator 113 configured to obtain the encoded metadata 116, the encoded transport audio signals 138 and the encoded audio object metadata 112 and generate the bitstream 118 for potential transmission or storage.

In some embodiments the analyser and encoder 101 comprises an encoder controller 115. The encoder controller 115 can in some embodiments control the encoding implemented by the audio object metadata encoder 111 and the combined encoder core 109. In some embodiments encoder controller 115 is configured to determine the bitrate for the bitstream 118 and based on the bitrate control the encoding. In some embodiments the encoder controller 115 is further configured to control at least one of the audio object analyser 107, transport signal generator 105 and metadata generator in generating parameters.

The analyser and encoder 101 can in some embodiments be a computer or mobile device (running suitable software stored on memory and on at least one processor), or alternatively a specific device utilizing, for example, FPGAs or ASICs. The encoding may be implemented using any suitable scheme. In some embodiments the encoder 107 may further interleave, multiplex to a single data stream or embed the encoded MASA metadata, audio object metadata and stream separation metadata within the encoded (downmixed) transport audio signals before transmission or storage shown in FIG. 1 by the dashed line. The multiplexing may be implemented using any suitable scheme.

Furthermore with respect to FIG. 1 is shown an associated decoder and renderer 109 which is configured to obtain the bitstream 118 comprising encoded metadata 116, Encoded transport audio signals 138 and encoded audio object metadata 112 and from these generate suitable spatial audio output signals. The decoding and processing of such audio signals are known in principle and are not discussed in detail hereafter other than the decoding of the encoded ISM ratio metadata.

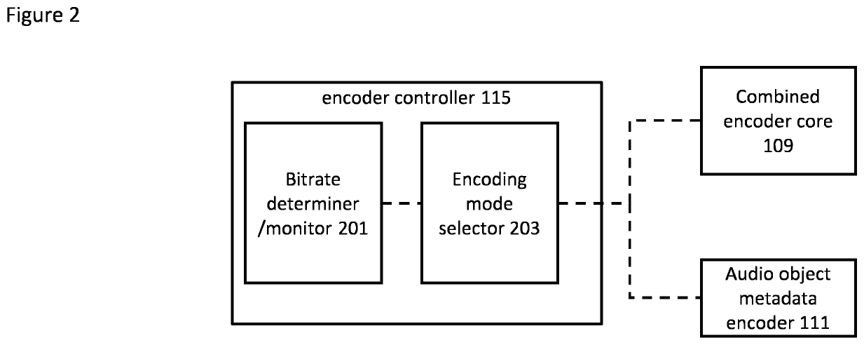

With respect to FIG. 2 is shown in further detail the encoder controller 115 according to some embodiments.

In this example the encoder controller 115 comprises a bitrate determiner/monitor 201 configured to determine and/or monitor the available bitrate for the bandwidth for the encoded audio and metadata. This could be determined based on a transmission path bandwidth estimation (and for example be based on an estimated signal strength) or a bandwidth storage determination to maintain the file for a determined time to be below a required size or by any suitable manner.

The bitrate determiner/monitor 201 can furthermore be configured to control an encoding mode selector 203. The encoder controller 115 can comprise a encoding mode selector 203 configured to select an encoding mode, for example based on the determined bandwidth or bitrate and then control the encoders, for example the combined encoder core 109 and audio object metadata encoder 111.

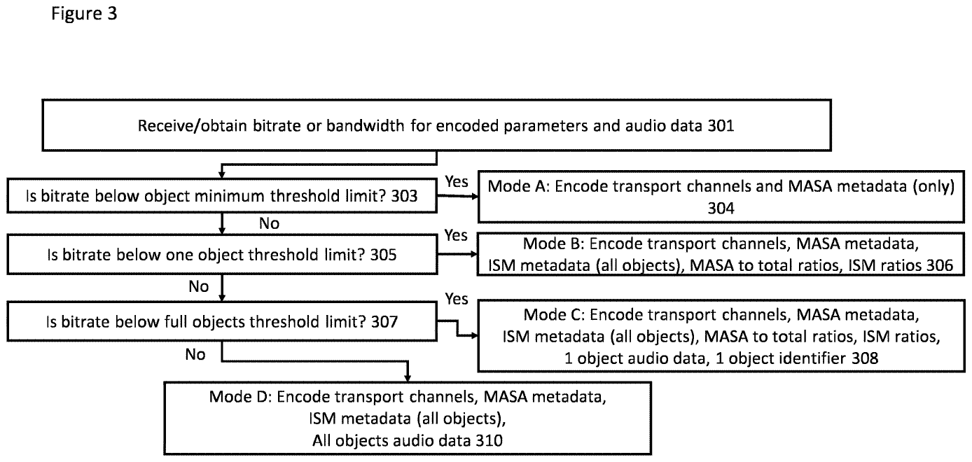

With respect to FIG. 3 is shown a flow diagram of an example operation of the encoder controller shown in FIG. 2 In this example there is an initial operation of receiving or obtaining or otherwise determining the bitrate or bandwidth for encoded parameters and audio data as shown in FIG. 3 by step 301.

Having obtained the available bandwidth or bitrate then a check can be made to determine whether the bitrate is below a first (or lowest or object minimum) threshold limit as shown in FIG. 3 by step 303.

Where the available bandwidth or bitrate is below the first (or lowest or object minimum) threshold limit then the encoders can be controlled to encode the transport channels and MASA metadata only (also shown as Mode A) as shown in FIG. 3 by step 304.

Where the available bandwidth or bitrate is above the first (or lowest or object minimum) threshold limit then a further check can be made to determine whether the bitrate is below a second (or lower or one object) threshold limit as shown in FIG. 3 by step 305.

Where the available bandwidth or bitrate is below the second (or lower or one object) threshold limit then the encoders can be controlled to encode transport channels, MASA metadata, ISM metadata (all objects), MASA to total ratios, ISM ratios (also shown as Mode B) as shown in FIG. 3 by step 306.

Where the available bandwidth or bitrate is above the second (or lower or one object) threshold limit then a further check can be made to determine whether the bitrate is below a third, higher or full object threshold limit as shown in FIG. 3 by step 307.

Where the available bandwidth or bitrate is below the third, higher or full object threshold limit then the encoders can be controlled to encode transport channels, MASA metadata, ISM metadata (all objects), MASA to total ratios, ISM ratios, and 1 object audio data, with 1 object identifier (also shown as Mode C) as shown in FIG. 3 by step 308.

Where the available bandwidth or bitrate is above the third, higher or full object threshold limit then the encoders can be controlled to encode Encode transport channels, MASA metadata, ISM metadata (all objects), All objects audio data (also shown as Mode D) as shown in FIG. 3 by step 310.

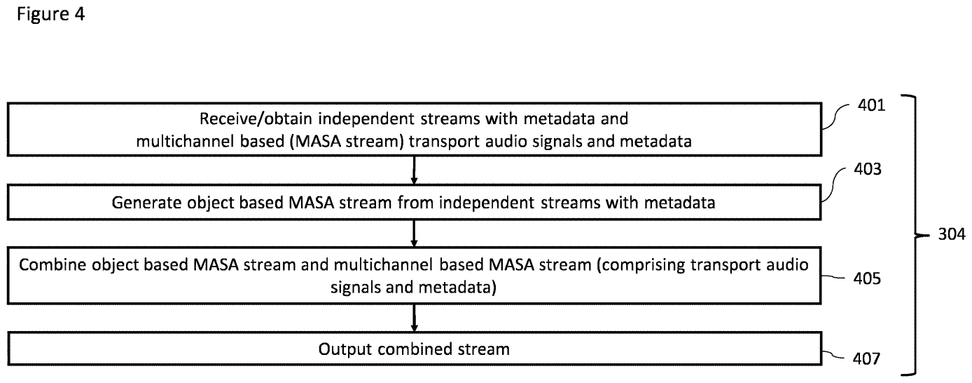

With respect to FIGS. 4 to 7 is shown flow diagrams showing a first (or lowest or combined) encoding mode as shown in FIG. 3 by step 304, a second (or lower or object metadata) encoding mode as shown in FIG. 3 by step 306, a third (or higher or one object) encoding mode as shown in FIG. 3 by step 308 and a fourth (or highest or all objects) encoding mode as shown in FIG. 3 by step 310 respectively. The encoding modes can for example be summarised by the following table

| Mode | Bitrate range/Format | Encoded parameters |
|---|---|---|
| A | -32 kbps | transport channels |
| | | MASA metadata |
| B | 48-80 kbps | Transport channels |
| | ISM_MASA_MODE_PARAM | MASA metadata |
| | | ISM metadata |
| | | MASA to total ratios |
| | | ISM ratios |
| C | 96-128 kbps | Transport channels |
| | ISM_MASA_MODE_ONE_OBJ | MASA metadata |
| | | ISM metadata |
| | | MASA to total ratios |
| | | ISM ratios |
| | | 1 object audio data |
| | | 1 object identifier |
| D | 160 kbps - | MASA Transport channels |
| | ISM_MASA_MODE_DISC | MASA metadata |
| | | ISM metadata |
| | | all objects audio data |

The bitrates shown herein are examples and it would be understood that they can be other specific values.

For example FIG. 4 shows the mode A encoding method, the first (or lowest or combined) encoding mode as shown in FIG. 3 by step 304 in further detail. Thus for very low total bitrates (for example less or equal to 32 kbps) all encoding is implemented using a MASA representation.

Thus for example there is an operation of receiving/obtaining the object based streams (independent streams with metadata) and multichannel based (MASA stream) transport audio signals and metadata as shown in FIG. 4 by step 401.

Then, as shown in FIG. 4 by step 403, there is an operation of generating an object based MASA stream from the object streams (independent streams with metadata). This object based MASA stream can in some embodiments be created from the object stream using, for example, the methods presented in WO2019086757A1.

After this, as shown in FIG. 4 by step 405, the object based MASA stream and multichannel based MASA stream are combined. In some embodiments the original MASA stream and the MASA stream created from the objects can be combined using the method presented in GB2574238. The decoder gets the objects and the MASA audio content in the MASA format.

Then the combined stream is output as shown in FIG. 4 by step 407. In such embodiments the object audio content (together with the MASA audio content) is present in the decoded audio scene, but the objects cannot be edited nor separated from the scene at the decoder.

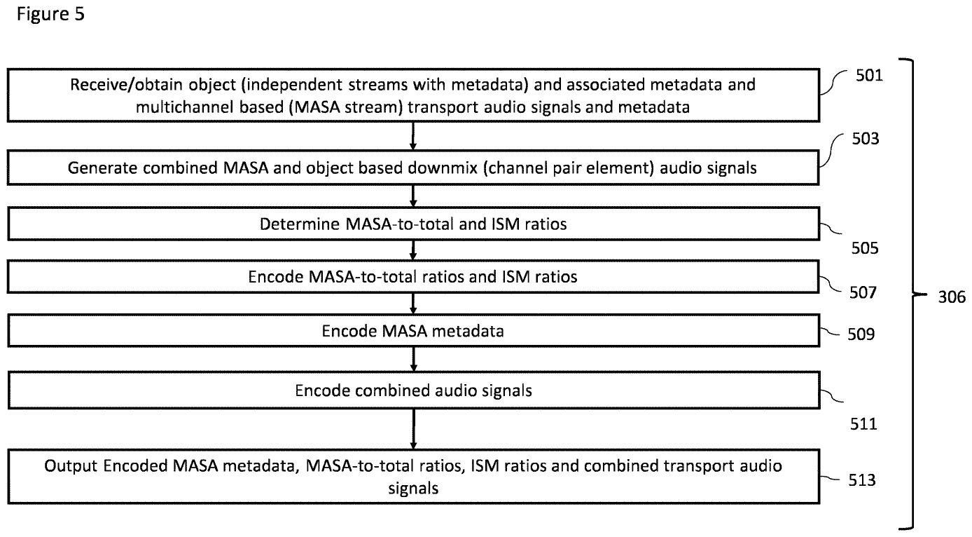

FIG. 5 shows the mode B encoding method, the second (or lower or object metadata) encoding mode as shown in FIG. 3 by step 306. Thus for low bit-rates (for example between 48 kbps and 80 kbps) and since there are a more bits available, there is a possibility to parameterize the audio scene, by sending one common audio data downmix, the MASA metadata, the ISM metadata, and additional parameter sets indicating for each time frequency tile how much of the signal corresponds to the MASA component out of the total audio scene (in other words this can be presented or indicated by the MASA-to-total energy ratios) and ratios indicating how the audio scene corresponding to the objects is distributed between the ISMs (in other words this can be presented or indicated by the ISM ratios).

Thus for example there is a method step of receiving/obtaining the object based streams (independent streams with metadata) and multichannel based (MASA stream) transport audio signals and metadata as shown in FIG. 5 by step 501.

Then, as shown by step 503 in FIG. 5, generate a combined MASA and object based downmix (channel pair element) audio signals. In other words, the audio content of MASA and the objects is downmixed to 2 channels (channel pair element CPE).

The MASA-to-total ratios and the ISM ratios can be determined as shown in FIG. 5 by step 505.

The MASA-to-total ratios and the ISM ratios can then be encoded based on any suitable encoding method. For example the ISM ratios can be encoded using a lattice encoding method or the MASA-to-total ratios encoded by DCT transforming followed by entropy coding (for example such as described in WO2022/200666). The encoding of the MASA-to-total ratios and the ISM ratios is shown in FIG. 5 by step 507.

Furthermore the MASA metadata can then be encoded based on any suitable MASA metadata encoding method as shown in FIG. 5 by step 509.

The combined audio signals can then be encoded based on any suitable audio signal encoding method as shown in FIG. 5 by step 511.

The encoder can then output Encoded MASA metadata, MASA-to-total ratios, ISM ratios and combined transport audio signals as shown in FIG. 5 by step 513.

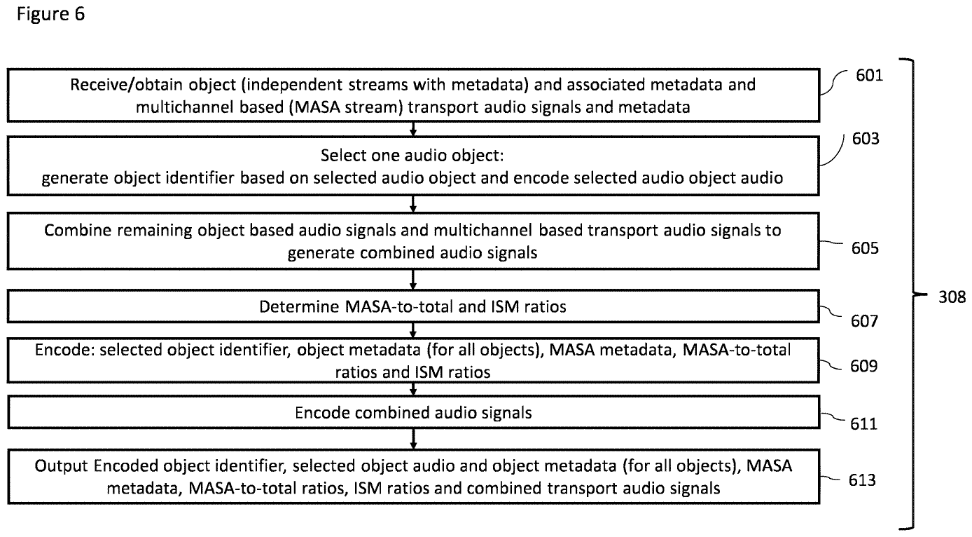

FIG. 6 shows the mode C encoding method, the third (or higher or one object) encoding mode as shown in FIG. 3 by step 308. Thus in medium or higher bitrates (for example bitrates larger or equal to 96 kbps and lower than 160 kbps), the audio content of one object is separated and sent independently. In addition, the downmix formed from the MASA transport channels and the rest of the objects are sent under MASA format with the additional parameters of the MASA-to-total energy ratios and ISM ratios. Moreover, the ISM metadata is sent, and an identifier describing which object was separated. At each frame it is decided which object is to be separated. The decision may, e.g., be based on the relative level of the objects with respect to other objects (e.g., separate the loudest object). This is explained in detail in WO2022/214730.

Thus for example there is a method step of receiving/obtaining the object based streams (independent streams with metadata) and multichannel based (MASA stream) transport audio signals and metadata as shown in FIG. 6 by step 601.

Then, as shown by step 603 in FIG. 6, one audio object is selected and an object identifier generated based on selected audio object. Furthermore the audio signal associated with the selected audio object is encoded. Any suitable audio signal encoder may be used for encoding the audio signal of the selected object. For example, the same or similar audio signal encoder as used for encoding the MASA audio signal(s) can be employed.

Then a combined MASA and remaining (or non-selected) object based transport audio signals (or downmix) is generated as shown by FIG. 6 by step 605. The object transport signals can be created in the same manner as presented in the previous mode, mode B, with the difference being that the selected or separated object not included within the mix. For example the multichannel or MASA audio signals and the (non-selected) object transport signals can be summed together to generate the combined transport audio signals.

The MASA-to-total ratios and the ISM ratios can be determined as shown in FIG. 6 by step 607.

The object identifier, MASA metadata, MASA-to-total ratios and the ISM ratios can then be encoded based on any suitable lattice encoding or entropy encoding method as shown in FIG. 6 by step 609. The encoding of the MASA-to-total energy ratio encoding can be implemented in the manner as described in WO2022/200666. The encoding of the ISM ratios is described later in further detail.

The combined audio signals can then be encoded based on any suitable MASA audio signal encoding method as shown in FIG. 6 by step 611. The encoding is of the combined transport audio signals can employ any suitable transport audio signal encoding, for example the audio signal(s) encoder of the IVAS encoder.

In other words the separated object is determined, separated and encoded as described in WO2022/214730, and for the remaining objects and the MASA stream the processing works as was described in WO2022/200666.

The encoder can then output the encoded object identifier, MASA metadata, MASA-to-total ratios, ISM ratios, object metadata (for all objects), selected single object audio signal and combined transport audio signals as shown in FIG. 6 by step 613.

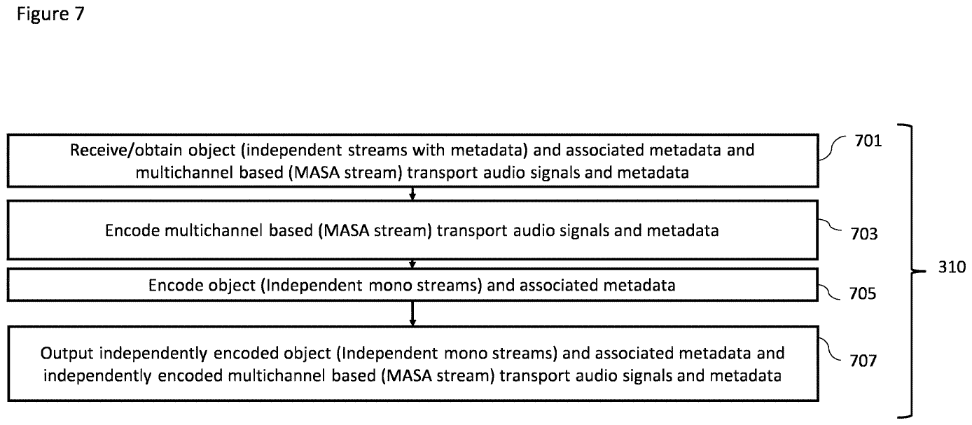

FIG. 7 shows the mode D encoding method, the fourth (or highest or all objects) encoding mode as shown in FIG. 3 by step 310. Thus in the higher bitrates (for example bitrates above or equal to 160 kbps) the two input audio formats, MASA and ISM are independently encoded and transmitted in the same bitstream (in other word using a single instance of the IVAS codec).

Thus for example there is a method step of receiving/obtaining the object based streams (independent streams with metadata) and multichannel based (MASA stream) transport audio signals and metadata as shown in FIG. 7 by step 701.

Then, as shown by step 703 in FIG. 7, there is encoded the multichannel based (MASA stream) transport audio signals and metadata based on any suitable MASA encoding method.

The object (independent streams with metadata) and associated metadata can furthermore be encoded as shown in FIG. 7 by step 705. Any suitable mono encoder can be employed to implement the encoding, for example an EVS based mono encoder block.

The encoder can then output the independently encoded object (independent streams with metadata) and associated metadata and independently encoded multichannel based (MASA stream) transport audio signals and metadata as shown in FIG. 7 by step 707.

With respect to the following the generation and encoding of the ISM ratio values, such as determined and encoded within the encoding modes B and C, is described in further detail.

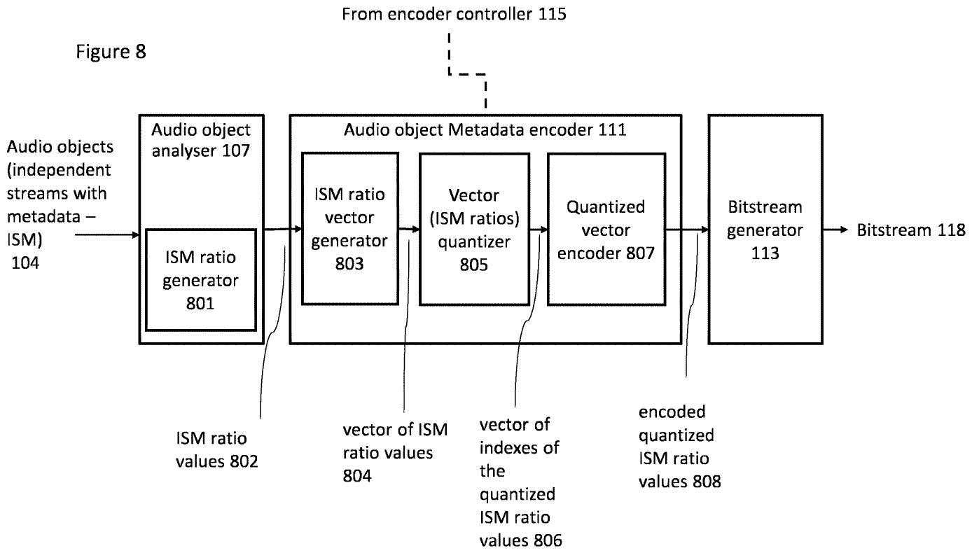

Thus with respect to FIG. 8 is shown in further detail the audio object analyser 107 and audio object metadata encoder 111 according to some embodiments. Although in some embodiments the MASA-to-total ratios and the directions (i.e., the azimuth and elevation angle per object) are forwarded and encoded by the audio object metadata encoder 111, the specific encoding of the directions and MASA-to-total ratio is not described herein in any further detail. For example WO2022/200666 describes a suitable MASA-to-total ratio encoding method and PCT/EP2017/078948 and U.S. Pat. No. 11,475,904 describes a suitable direction value encoding method.

In some embodiments the audio object analyser 107 comprises an ISM ratio generator 801. The ISM ratio generator 801 is configured to generate independent streams with metadata (ISM) ratios associated with the audio object signals (the independent streams with metadata) 104.

In some embodiments the ISM ratios can be obtained as follows.

First, the object audio signals s_{obj}(t, i) are transformed to time-frequency domain s_{obj}(b, n, i) (where t is the temporal sample index, b the frequency bin index, n the temporal frame index, and i the object index. The time-frequency domain signals can, e.g., be obtained via short-time Fourier transform (STFT) or complex-modulated quadrature filterbanks (QMF) (or low-delay variants of them).

Then, the energies of the objects are computed in frequency bands

$${E}_{obj} ( k , n , i ) = {\sum }_{{b}_{k , low}}^{{b}_{k , high}} {\vert {S}_{obj} ( b , n , i ) \vert}^{2}$$

where b_{k,low} is the lowest and b_{k,high} the highest bin of the frequency band k. Then, the ISM ratios ξ(k, n, i) can be computed as

$$ξ ( k , n , i ) = \frac{{E}_{obj} ( k , n , i )}{{\sum }_{i = 0}^{l - 1} {E}_{obj} ( k , n , i )}$$

where I is the number of objects.

In some embodiments, the temporal resolution of the ISM ratios may be different than the temporal resolution of the time-frequency domain audio signals s_{obj}(b, n, i) (i.e., the temporal resolution of the spatial metadata may be different than the temporal resolution of the time-frequency transform). In those cases, the computation (of the energy and/or the ISM ratios) may include summing over multiple temporal frames of the time-frequency domain audio signals and/or the energy values.

The ISM ratios are numbers between 0 and 1 and they correspond to the fraction with which one object is active within the audio scene created by all the objects. For each object there is one ISM ratio per frequency sub-band and time subframe. In the following examples, it is assumed that one temporal frame contains N subframes. In these examples there are N=4 subframes which when the length of the frame is 20 milliseconds, causes the length of the subframe to be 5 milliseconds (i.e., there are 4 subframes in a frame). In other embodiments, the lengths of the frames and the subframes may be different. Moreover, the frame size generated for example by the time-frequency transform may be different. In these embodiments the ISM ratios may have been computed by summing the values over multiple frames (or they may be called slots) of the time-frequency transform.

As discussed above the ISM ratios are passed to the audio object metadata encoder 111.

As discussed above in some embodiments the audio object metadata encoder 111 is configured to encode the ISM ratios.

In some embodiments the audio object metadata encoder 111 comprises an ISM ratio vector generator 803 which is configured to receive the ISM ratio values and generate a vector representation of the ISM ratios for the sub-band and the subframe. In other words the vector describes the ISM values for all objects of a given time-frequency tile. The Vector of ISM ratio values 804 can then be passed to the vector (ISM ratios) quantizer 805. The vector can also be known as an arrangement of the ISM ratio values.

In some embodiments the audio object metadata encoder 111 comprises a vector (ISM ratios) quantizer 805 configured to receive the vector of ISM ratios 804 and quantize them. In some embodiments for each sub-band and time subframe the ratios can be scalarly quantized on nb=3 bits. As such the quantization of each of the ratios returns a positive integer value in binary from 000 to 111 (or 0 to 7 in decimal or base 10 form). In other embodiments the quantization can be performed using any suitable number of bits. Thus although the following examples show a uniform scalar quantizer based on 3 bits for each value. It can also be a non-uniform scalar quantizer. The distribution of the indexes does not influence the indexing. However, this could in principle be taken into account by observing that some vector indexes are more probable than others. Quantizers based on more than 3 bits can be employed in some embodiments.

By definition, for each subband and subframe, the sum across objects is 1. For each subband and time subframe the values are scalarly quantized on nb=3 bits. Because the ISM ratios sum up to 1, there is a corresponding relationship between the quantization indexes and they should sum up to 2\hat{ }nb-1 (=7). This enables reducing the number of indexes that are sent. They can be sent for one object less for each subband. However, due to the non-linearity of the quantization operation, the reconstruction at the decoder may not be optimal respecting the condition of summing up to a constant in the index domain. As such in some embodiments the quantization operation can further comprise a quantization optimization operation and features a quantization of a constrained vector.

Thus in some embodiments the quantization of the indexes for each subband and each subframe can be implemented based on the following operations:

```
1. For o = 0:O-1
  a. Quantize to the lowest nearest neighbour the ISM ratios rISM (o)
    and obtain the index idx(o) (i.e., from the two adjacent possible
    quantized values, select the one that has the lower value).
2. End
3. Calculate the reconstructed values of the ISM ratios using the formula
  ${\sum }_{o = 0}^{O - 1} idx ( o ) \cdot σ , where σ is the quantization step .$
4. Calculate the Euclidean distortion between the reconstructed ratios and
  the unquantized ones
5. Calculate sum of quantized indexes, SI
6. While SI < K
  a. Check which quantized index to increase by 1 unit for a possible
    decrease of the resulting Euclidean distortion in the ISM ratio
    domain
  b. Select best component
      i. The one that decreases the most the Euclidean distortion
        or, if there cannot be any decrease, the one that increases
        it by the least amount.
  c. Update the selected index, by adding one unit
  d. Update sum of quantized indexes (SI = SI + 1)
7. End While
8. Encode the quantized indexes.
```

It is to be noted that the modifications of the indexes are performed only by increasing their values, because the quantization operation is forced to always take the lowest neighbour in the scalar quantization.

This quantization process ensures that the sum of indexes across the objects equals K.

The vector of indexes of the quantized ISM ratio values 806 can then be passed to a quantized vector encoder 807. The audio object metadata encoder 111 can in some embodiments comprise a quantized vector encoder 807. The quantized vector encoder 807 can be configured to obtain the vector of indexes of the quantized ISM ratio values 806 and from these generate suitable encoded quantized ISM ratio values 808 which can for example be passed to a bitstream generator 113 to be included within the bitstream 118.

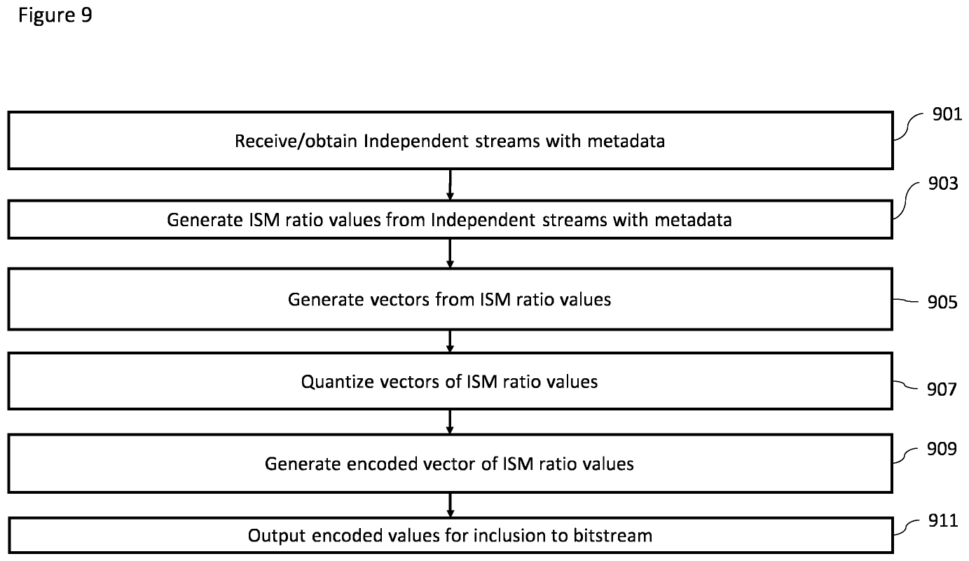

With respect to FIG. 9 is shown a flow diagram which summarises the operations of the example audio object analyser 107 and example audio object metadata encoder 111 shown in FIG. 8.

The initial operation is one of receiving/obtaining the independent streams with metadata as shown in FIG. 9 by step 901.

Then the following operation is performed of generating ISM ratio values from the independent streams with metadata as shown in FIG. 9 by step 903.

From the ISM ratios the next operation is generating vectors from ISM ratio values as shown in FIG. 9 by step 905.

Having determined the vector of ISM ratio values, they can be quantized to generate quantized vectors of ISM ratio values as shown in FIG. 9 by step 907.

Then from the quantized vectors are generated index values representing the encoded quantized vectors as shown in FIG. 9 by step 909.

The encoded ISM vector index values can then be output for inclusion to the bitstream as shown in FIG. 9 by step 911.

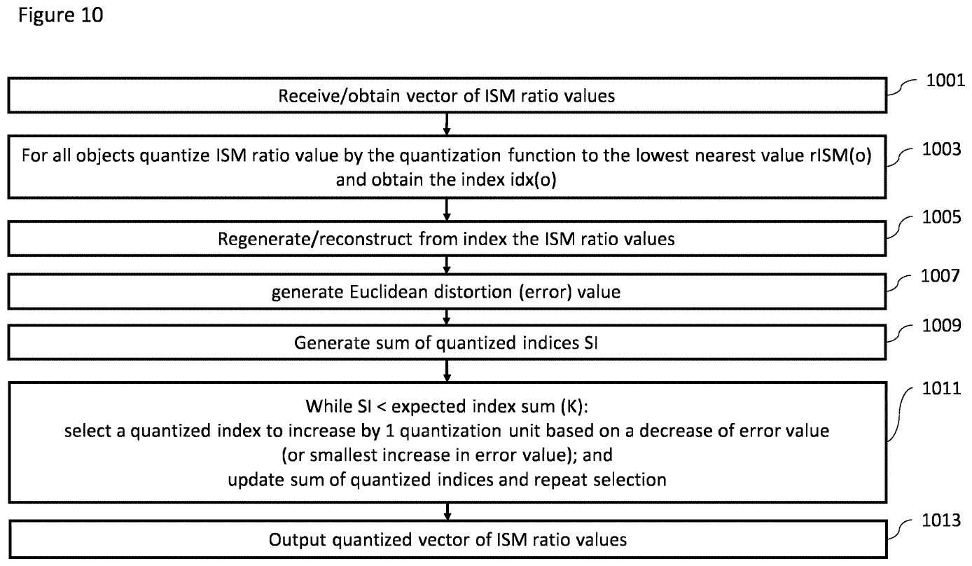

Furthermore with respect to FIG. 10 is further described the quantization of the vector of ISM ratio values to generate quantized vectors of ISM ratio values as shown in FIG. 9 by step 907.

Thus initially the vector of ISM ratio values are received or otherwise obtained as shown in FIG. 10 by step 1001.

Then the vector of ISM ratio values is quantized by the quantization function such that for object o there is a respective quantized element of the vector with a lowest nearest value rISM(o) and then obtain the index idx(o) associated with the lowest nearest value as shown in FIG. 10 by step 1003.

Furthermore there is an operation for the vector for regenerating or reconstructing from index values the ISM ratio values as shown in FIG. 10 by step 1005.

Furthermore based on the reconstructed ISM ratio values and the original ISM ratio values a Euclidean distortion (error) value is generated as shown in FIG. 10 by step 1007.

Additionally the sum of the quantized indices, which can be designated SI, is determined as shown in FIG. 10 by step 1009.

Then an optimization operation or step as shown in FIG. 10 by step 1011 is implemented while the sum of the quantized indices, SI, is less than the expected index sum value K. This optimization can involve selecting a quantized index and increasing the index by 1 quantization unit. The quantized index is selected in some embodiments based on a decrease of error value (or smallest increase in error value). The distortion value and the sum of quantized indices SI are then updated. As described these select, increment and update operations until SI is the expected value of K.

Once optimized the quantized vector of ISM ratio values are then output as shown in FIG. 10 by step 1013.

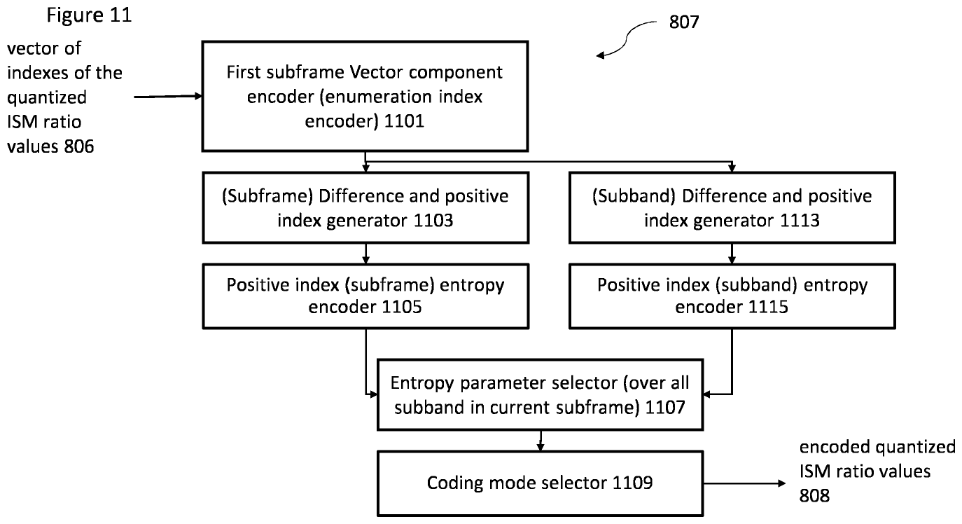

With respect to FIG. 11 the quantized vector (of ISM ratio values) encoder 807 is shown in further detail.

The quantized vector encoder 807 comprises in some embodiments a first subframe vector component encoder 1101. The first subframe vector component encoder 1101 Is configured to obtain the vector quantized ISM ratio index values, which can be defined as B×N O-dimensional integer vectors of ISM ratio indexes. The first subframe vector component encoder 1101 can then encode for each sub-band of the first sub-frame the vector of O integer values as an enumeration index. The encoding of an ISM ratio index vector using an enumeration index encoding method is discussed in further detail in co-pending GB application 2217884.2.

The quantized vector encoder 807 comprises in some embodiments a subframe difference and positive index generator 1103 configured to determine for succeeding subframe vectors a difference index with respect to the previous sub-frame and further convert or transform the difference index into a positive index.

Additionally the quantized vector encoder 807 comprises in some embodiments comprises a positive index (subframe) entropy encoder 1105 configured to apply a entropy encoding (for example a Golomb-Rice encoding) with a parameter 0 and parameter 1 and determine or estimate for each a corresponding number of bits required.

The quantized vector encoder 807 comprises in some embodiments a subband difference and positive index generator 1113 configured to determine for succeeding subbands a difference index with respect to the previous subband and further convert or transform the difference index into a positive index.

The quantized vector encoder 807 comprises in some embodiments comprises a positive index (subband) entropy encoder 1115 configured to apply an entropy encoding (for example a Golomb-Rice encoding) with a parameter 0 and parameter 1 and determine or estimate for each a corresponding number of bits required.

The quantized vector encoder 807, furthermore, in some embodiments comprises an entropy parameter selector (over all subbands in current subframe) 1107 which is configured to select the optimal entropy encoding (GR) parameter for using the mode over all subband data in current subframe.

The quantized vector encoder 807 in some embodiments comprises a coding mode selector 1109 configured to select the differential coding mode (either sub-band or sub-frame differential encoding) for the current subframe as the one providing the shortest codelength for the subfame.

The encoded quantized ISM ratio values 808 can be output from the quantized vector encoder 807.

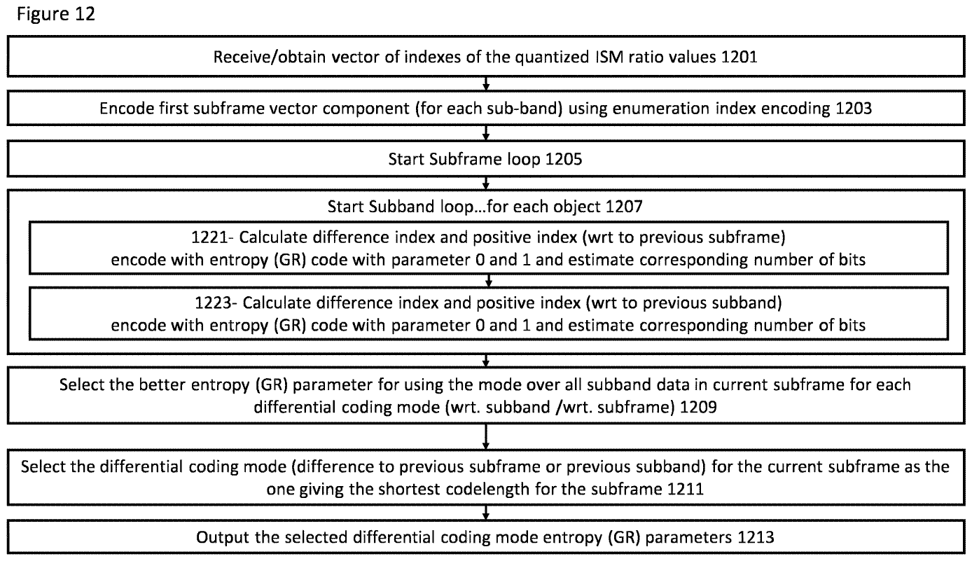

With respect to FIG. 12 is shown a flow diagram of the operations of the example quantized vector encoder 807 as shown in FIG. 11 according to some embodiments.

Thus is shown receiving or otherwise obtaining vector of indexes of the quantized ISM ratio values 806 as shown in FIG. 12 by step 1201.

Then is the operation of encoding a first subframe vector component (for each sub-band) using enumeration index encoding as shown in FIG. 12 by step 1203.

A subframe loop (for succeeding subframes) may then be initialized as shown in FIG. 12 by step 1205.

Furthermore a sub-band loop may then also be started as shown in FIG. 12 by step 1207.

Then for each object as shown by FIG. 12 step 1221, the method comprises calculating a difference index (wrt to previous subframe), transforming the difference index into a positive index and encoding the positive index with entropy (GR) code with parameter 0 and 1 and estimating a corresponding number of bits.

Then for each object as shown by FIG. 12 step 1223, the method comprises calculating a difference index (wrt to previous subband), transforming the difference index into a positive index and encoding the positive index with entropy (GR) code with parameter 0 and 1 and estimating a corresponding number of bits.

Once this sub-band loop has finished then for each differential coding mode (differential wrt. subband or differential wrt. subframe) then select the ‘optimal’ GR parameter for using the mode over all subband data in current subframe as shown in FIG. 12 by step 1209.

Then once the subframe loop has finished then select the differential coding mode (difference to previous subframe or previous subband) for the current subframe as the one giving the shortest codelength for the subframe as shown in FIG. 12 by step 1211.

Finally output the selected differential coding mode entropy (GR) parameters as shown in FIG. 12 by step 1213.

This operation can be represented as
1. First subframe ISM ratio quantized data is encoded with the enumeration index
   a. For each subband of the first subframe
      i. Encode the vector of O integer values that sum up to the value 2 \hat{ }nb-1 (=7), as an enumeration index.
   b. End for
2. For each subframe 1 to N-1
   a. For each subband from 0 to B-1
      i. Calculate for each object the difference index with respect to previous subframe
      ii. Transform the difference index to positive index
      iii. The positive indexes are encoded with GR code with parameter 0 and corresponding number of bits are estimated
      iv. The positive indexes are encoded with GR code with parameter 1 and corresponding number of bits are estimated
      v. Calculate for each object the difference index with respect to previous subband (if there is no previous subband, use data from previous subframe)
      vi. Transform the difference index to positive index
      vii. The positive indexes are encoded with GR code with parameter 0 and corresponding number of bits are estimated
      viii. The positive indexes are encoded with GR code with parameter 1 and corresponding number of bits are estimated
   b. End For
   c. For each differential coding mode (wrt. subband/wrt. subframe)
      i. Select the optimal GR parameter for using the mode over all subband data in current subframe
   d. End for
   e. Select the differential coding mode (difference to previous subframe or previous subband) for the current subframe as the one giving the shortest codelength for the subframe
3. End for

The tested GR parameter values are 0 and 1 but also other or more GR parameter values can be considered.

The bitstream for one frame thus comprises the following ISM ratios related data:
Vector index for the first subframes of all subbands
For each subframe, with the exception of the first one
   1 bit indicating the differential coding mode (with respect to previous subframe or previous subband)
   1 bit indicating the GR order (0 or 1)
   GR encoded differential indexes

In some embodiments for the first subband, the difference is taken with respect to the previous subframe data, because there is no subband data to look back to. The GR parameter and differential coding flags are decided for each subframe, and they are valid for all subbands corresponding to that subframe.

In some embodiments the ISM ratios are in a variable such as:

```
float ism_ratios[num_subframes][num_bands][num_objects];
Then, quantizing can employ ‘for loops’ in order to quantize the values:
for i = 1:num_subframes
  for j = 1:num_bands
    quantized_ism_ratios(i,j,:) = quantize_ratios(ism_ratios(i,j,:));
  end
end
where the quantized values would be in a variable:
int quantized_ism_ratios[num_subframes][num_bands][num_objects];
```

In such embodiments there would be no explicit generation of the vector but the data is passed to the quantization operation in a suitable form.

Alternatively, in some embodiments, the selection could be also implemented to be valid across subframes and decided for each subband, or to be decided for each subframe and subband individually.

In some embodiments when processing the data, there is special case where all ISM ratios are 0 which would not obey the constant sum constraint indicated above. This case corresponds to the example where there is no audio signal in the objects or no audio signal at all. The information that there is no audio signal in the objects, can be inferred from the MASA-to-total energy ratios. If the MASA-to-total energy ratio for a TF tile (identified by subband and subframe) is 1, then there is no need to send the ISM ratios for that TF tile.

Furthermore when there is no audio signal at all, the MASA-to-total energy ratios can be forced to 1, allowing thus to infer the degenerate all zero values case of ISM ratios from the MASA-to-total energy ratio values.

In some embodiments if there is no energy in any objects, the ISM ratios can be set to 1/num_objects which would force the ISM ratios to sum to 1, and no specific handling would be needed since the information is present in the corresponding encoded MASA to total ratios.

The decoder can be configured to decode the ISM values using the opposite processes to those described above. As such a decoder can be configured to obtain the ISM ratio vales from the encoded vector values based on the following operations:

```
1. For sf = 1:num_subframes
  1.1. Decode/Read ISM ratio index vectors for all subbands
  1.2. Save current subframe data to previous subframe data
  1.3. Reconstruct ISM ratios from the ISM ratio indexes
2. End for
Decoding the ISM ratio indexes for the subframe sf:
1. If first subframe
  1.1. For b = 1:num_subbands
    1.1.1. Read index for the ISM ratios index vector for subband b
    1.1.2. Decode index (According to NC327207) into vector of indexes
  1.2. End for
2. Else
  2.1. Read differential mode bit
  2.2. Read Golomb Rice order
  2.3. For b = 1:num_subbands
      2.3.1. For i = 1:num_objects-1
      2.3.1.1. Read and decode GR code into positive index
      2.3.1.2. Transform positive index into integer corresponding to
      difference index
    2.3.2. End for
  2.4. End for
  2.5. If differential mode with respect to previous subframe
    2.5.1. For b = 1:num_subbands
      2.5.1.1. For i = 1:num_objects-1
        2.5.1.1.1. Calculate ISM ratio index of subband b as
        sum of previous subframe ISM ratio index + the
        decoded difference
      2.5.1.2. End for
      2.5.1.3. Calculate index corresponding to last object such that
    the sum of indexes across objects is the constant K
    2.5.2. End for
  2.6. Else
    2.6.1. Calculate ISM ratio indexes for num_objects-1 of the first
  subband as sum of previous subframe first subband ISM ratio index +
  the decoded difference
    2.6.2. For b = 2:num_subbands
      2.6.2.1. For i = 1:num_objects-1
        2.6.2.1.1. Calculate ISM ratio index of subband b as
      sum of previous subband ISM ratio index + the decoded
      difference
      2.6.2.2. End for
      2.6.2.3. Calculate index corresponding to last object such that
    the sum of indexes across objects is the constant K
    2.6.3. End for
  2.7. End if
```

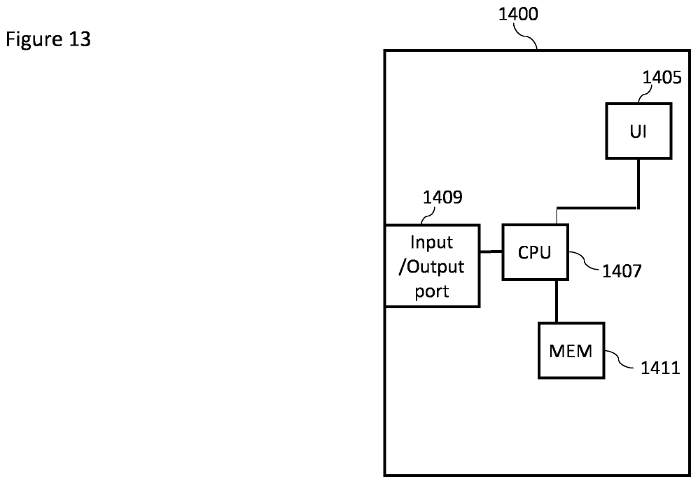

With respect to FIG. 13 an example electronic device which may be used as any of the apparatus parts of the system as described above. The device may be any suitable electronics device or apparatus. For example, in some embodiments the device 1400 is a mobile device, user equipment, tablet computer, computer, audio playback apparatus, etc. The device may for example be configured to implement the encoder/analyser part and/or the decoder part as shown in FIG. 1 or any functional block as described above.

In some embodiments the device 1400 comprises at least one processor or central processing unit 1407. The processor 1407 can be configured to execute various program codes such as the methods such as described herein.

In some embodiments the device 1400 comprises at least one memory 1411. In some embodiments the at least one processor 1407 is coupled to the memory 1411. The memory 1411 can be any suitable storage means. In some embodiments the memory 1411 comprises a program code section for storing program codes implementable upon the processor 1407. Furthermore, in some embodiments the memory 1411 can further comprise a stored data section for storing data, for example data that has been processed or to be processed in accordance with the embodiments as described herein. The implemented program code stored within the program code section and the data stored within the stored data section can be retrieved by the processor 1407 whenever needed via the memory-processor coupling.

In some embodiments the device 1400 comprises a user interface 1405. The user interface 1405 can be coupled in some embodiments to the processor 1407. In some embodiments the processor 1407 can control the operation of the user interface 1405 and receive inputs from the user interface 1405. In some embodiments the user interface 1405 can enable a user to input commands to the device 1400, for example via a keypad. In some embodiments the user interface 1405 can enable the user to obtain information from the device 1400. For example the user interface 1405 may comprise a display configured to display information from the device 1400 to the user. The user interface 1405 can in some embodiments comprise a touch screen or touch interface capable of both enabling information to be entered to the device 1400 and further displaying information to the user of the device 1400. In some embodiments the user interface 1405 may be the user interface for communicating.

In some embodiments the device 1400 comprises an input/output port 1409. The input/output port 1409 in some embodiments comprises a transceiver. The transceiver in such embodiments can be coupled to the processor 1407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable radio access architecture based on long term evolution advanced (LTE Advanced, LTE-A) or new radio (NR) (or can be referred to as 5G), universal mobile telecommunications system (UMTS) radio access network (UTRAN or E-UTRAN), long term evolution (LTE, the same as E-UTRA), 2G networks (legacy network technology), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (IoT) RAN and Internet Protocol multimedia subsystems (IMS), any other suitable option and/or any combination thereof.

The transceiver input/output port 1409 may be configured to receive the signals.

In some embodiments the device 1400 may be employed as at least part of the synthesis device. The input/output port 1409 may be coupled to headphones (which may be a headtracked or a non-tracked headphones) or similar and loudspeakers.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The term “non-transitory,” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus for encoding an audio object parameter, the apparatus comprising at least one processor and at least one memory storing instructions that, when executed by the at least one processor, cause the apparatus at least to perform:
obtaining, for time-frequency elements of a frame comprising more than one time element and more than one frequency element, a plurality of ratio parameters for an audio object within an audio environment, the audio environment comprising more than one audio object and the ratio parameters configured to identify a distribution of a specific object within the object part of the total audio environment and for a specific time-frequency element;
quantizing selections of the ratio parameters, wherein the selections are associated with audio objects within a specific frame time-frequency element;
encoding a first set of the selections of ratio parameters based on an indexing of the selections; and
encoding the remaining selections of the ratio parameters for the frame based on a differential encoding of the selections based on the first set of selection of ratio parameters or a precedingly indexed time element or frequency element selection of ratio parameters,
wherein the apparatus is configured to quantize the selection of the ratio parameters by:
quantizing, using a lowest nearest neighbour scalar quantization, ratio values within a specific selection to obtain quantization index values;
calculating reconstructed values of the ratio parameters for the specific selection;
calculating an error value based on the difference between the reconstructed ratio values and the specific selection of ratio parameter values;
determining a sum of quantized index values; and
selecting at least one quantized index value to increment such that the sum of quantized index values is equal to an expected index sum.

2. The apparatus as claimed in claim 1, wherein the selections are vectors of the ratio parameters and the apparatus is further for generating the vectors of the ratio parameters representing the ratio parameters.

3. The apparatus as claimed in claim 1, wherein the apparatus is configured to encode a first set of the selections of ratio parameters based on an indexing of the selections by generating an integer value based on an indexing from the selection, wherein the generated integer value represents the ratio parameters for the audio objects.

4. The apparatus as claimed in claim 3, wherein the apparatus is configured to generate the integer value based on the indexing from the selection of ratio parameters by:
generating a single number value by appending elements from the selection of ratio parameters; and
generating the index from the single number, by performing an iteration loop from a zeroth iteration up to and including the single number of iterations and sequentially associating index values to iteration loop iteration numbers which have a valid selection of ratio parameters, wherein the integer value is the highest index value.

5. (canceled)

6. The apparatus as claimed in claim 1, wherein the apparatus is configured to select at least one quantized index value to increment such that the sum of quantized index values is equal to an expected index sum is by one of:
selecting the at least one quantized index value to increment based on identifying a greatest decrease within the error value when the index value is incremented; or
selecting the at least one quantized index value to increment based on identifying a minimum increase within the error value when the index value is incremented.

7. The apparatus as claimed in claim 1, wherein the apparatus is configured to quantize the selection of the ratio parameters is by:
determining for a specific selection of ratio parameters that the elements are zero; and
generating a further ratio parameter configured to identify a distribution of the object part of the total audio environment, the further ratio parameter value identifying that there is no object part contribution.

8. The apparatus as claimed in claim 1, wherein the apparatus is configured to encode the remaining selection of the ratio parameters for the frame based on differential encoding of the selections based on the first set of selection of ratio parameters or a precedingly indexed time element or frequency element selection of ratio parameters by:
performing with respect to a set of selection of ratio parameters with respect to a specific time element of the frame:
determining a number of bits required for entropy coding the differences between the quantized frequency elements for a first and second entropy coding parameters;
determining a number of bits required for entropy coding the differences between the quantized time elements for the first and second entropy coding parameters;
selecting, for the specific time element, the first entropy coding parameter or the second entropy coding parameter based on a smaller number of bits required for coding the differences in the specific time element of the frame; and
selecting one of the entropy coding of the differences between frequency elements or time elements for the selected first entropy coding parameter or the second entropy coding parameter based entropy coding based on a smaller number of bits required for coding the differences in the specific time element of the frame.

9. The apparatus as claimed in claim 8, wherein the apparatus is configured to differentially encode the selections based on the first set of selection of ratio parameters or a precedingly indexed time element or frequency element selection of ratio parameters by encoding the selected one of the entropy coding of the differences between frequency elements or time elements for the selected first entropy coding parameter or the second entropy coding parameter based entropy coding.

10. The apparatus as claimed in claim 1, wherein the apparatus is configured to encode the remaining selection of the ratio parameters for the frame based on a differential encoding of the selection of ratio parameters based on the first set of selection of ratio parameters or a precedingly indexed time element or frequency element selection of ratio parameters by:
performing with respect to a set of selection of ratio parameters with respect to a specific frequency element of the frame:
determining a number of bits required entropy coding quantized differences between frequency elements for a first and second entropy coding parameters;
determining a number of bits required entropy coding quantized differences between time elements for the first and second entropy coding parameters;
selecting, for the specific frequency element, the first entropy coding parameter or the second entropy coding parameter based on a smaller number of bits required for coding the differences in the specific time element of the frame; and
selecting, for the specific frequency element, one of the entropy coding of differences between frequency elements or time elements for the selected first entropy coding parameter or the second entropy coding parameter based entropy coding based on a smaller number of bits required for coding the differences in the specific time element of the frame.

11. The apparatus as claimed in claim 10, wherein the apparatus is configured to differentially encode the selections based on the first set of selection of ratio parameters or a precedingly indexed time element or frequency element selection of ratio parameters by encoding the selected one of the entropy coding of the differences between frequency elements or time elements for the selected first entropy coding parameter or the second entropy coding parameter based entropy coding.

12. The apparatus as claimed in claim 8, wherein the apparatus is configured to encode the remaining selection of ratio parameters of the ratio parameters for the frame based on a differential encoding of the selection of ratio parameters based on the first set of selection of ratio parameters or a precedingly indexed time element or frequency element selection of ratio parameters by:
generating an indicator indicating the selected first entropy coding parameter or the second entropy coding parameter; and
generating an indicator indicating the selected one of the entropy coding of differences between frequency elements or time elements for the selected first entropy coding parameter or the second entropy coding parameter based entropy coding.

13. The apparatus as claimed in claim 8, wherein the entropy coding is Golomb-Rice entropy coding and the first entropy coding parameter is a Golomb-Rice entropy coding order 0 and the second entropy coding parameter is a Golomb-Rice entropy coding order 1.

14. The apparatus as claimed in claim 8, wherein the apparatus is configured to encode the remaining selection of ratio parameters of the ratio parameters for the frame based on the differential encoding of the selection of ratio parameters based on the first set of selection of ratio parameters or the precedingly indexed time element or frequency element selection of ratio parameters by differential encoding of the selection of ratio parameters based on the precedingly indexed time element selection of ratio parameters where there is no precedingly indexed frequency element selection of ratio parameters.

15. The apparatus as claimed in claim 7, wherein the ratio parameters configured to identify a distribution of a specific object within the object part of the total audio environment are ISM ratios.

16. The apparatus as claimed in claim 15 wherein the further ratio parameter configured to identify a distribution of the object part of the total audio environment is a MASA-to-total energy ratio.

17. A further apparatus for decoding an audio object parameter, wherein the audio object parameter is encoded by
obtaining, for time-frequency elements of a frame comprising more than one time element and more than one frequency element, a plurality of ratio parameters for an audio object within an audio environment, the audio environment comprising more than one audio object and the ratio parameters configured to identify a distribution of a specific object within the object part of the total audio environment and for a specific time-frequency element;
quantizing selections of the ratio parameters, wherein the selections are associated with audio objects within a specific frame time-frequency element;
encoding a first set of the selections of ratio parameters based on an indexing of the selections; and
encoding the remaining selections of the ratio parameters for the frame based on a differential encoding of the selections based on the first set of selection of ratio parameters or a precedingly indexed time element or frequency element selection of ratio parameters,
wherein the quantizing the selection of the ratio parameters comprises:
quantizing, using a lowest nearest neighbour scalar quantization, ratio values within a specific selection to obtain quantization index values;
calculating reconstructed values of the ratio parameters for the specific selection;
calculating an error value based on the difference between the reconstructed ratio values and the specific selection of ratio parameter values;
determining a sum of quantized index values; and
selecting at least one quantized index value to increment such that the sum of quantized index values is equal to an expected index sum,
the further apparatus comprising at least one processor and at least one memory storing instructions that, when executed by the at least one processor, cause the apparatus at least to perform:
obtaining a bitstream comprising encoded ratio parameters, for time-frequency elements of a frame comprising more than one time element and more than one frequency element, the ratio parameters associated with audio object within an audio environment, the audio environment comprising more than one audio object and the ratio parameters configured to identify a distribution of a specific object within the object part of the total audio environment and for a specific time-frequency element;
decoding a first set of a selection of ratio parameters based on an indexing of the selection; and
decoding the remaining selection of the ratio parameters for the frame based on a differential decoding of the selection based on the first set of the selection of ratio parameters or a precedingly indexed time element or frequency element selection of the ratio parameters.

18. The further apparatus as claimed in claim 17, wherein the selection is a vector of the ratio parameters.

19. The further apparatus as claimed in claim 17, wherein the further apparatus is configured to decode the first set of the selection of ratio parameters based on the indexing of the selection by:
obtaining an integer value representing encoded ratio parameters;
converting the integer value to a selection of ratio parameters based on the indexing of the vector; and
regenerating at least one further ratio parameter from the selection of the ratio parameters.

20. The further apparatus as claimed in claim 19, wherein the further apparatus is configured to convert the integer value to the selection of ratio parameters based on the indexing of the vector by:
generating a single number value by appending elements from the selection of ratio parameters; and
generating the index from the single number, by performing an iteration loop from a zeroth iteration up to and including the single number of iterations and sequentially associating index values to iteration loop iteration numbers which have a valid selection of ratio parameters, wherein the integer value is the highest index value.

21. The further apparatus as claimed in claim 17, wherein the further apparatus is configured to decode the remaining selection of the ratio parameters for the frame based on a differential decoding of the selection based on the first set of the selection of ratio parameters or a precedingly indexed time element or frequency element selection of the ratio parameters by:
obtaining a difference indicator identifying a frequency difference or time difference encoding;
obtaining an entropy encoding indicator identifying an entropy encoding parameter; and
decoding the remaining selection of the ratio parameters for the frame based on the difference indicator and the entropy encoding indicator.

22. The further apparatus as claimed in claim 17, wherein the ratio parameters configured to identify a distribution of a specific object within the object part of the total audio environment are ISM ratios.

23. A method comprising, for encoding an audio object parameter:
obtaining, for time-frequency elements of a frame comprising more than one time element and more than one frequency element, a plurality of ratio parameters for an audio object within an audio environment, the audio environment comprising more than one audio object and the ratio parameters configured to identify a distribution of a specific object within the object part of the total audio environment and for a specific time-frequency element;
quantizing selections of the ratio parameters, wherein the selections are associated with audio objects within a specific frame time-frequency element;
encoding a first set of the selections of ratio parameters based on an indexing of the selections; and
encoding the remaining selections of the ratio parameters for the frame based on a differential encoding of the selections based on the first set of selection of ratio parameters or a precedingly indexed time element or frequency element selection of ratio parameters,
wherein the quantizing the selection of the ratio parameters comprises:
quantizing, using a lowest nearest neighbour scalar quantization, ratio values within a specific selection to obtain quantization index values;
calculating reconstructed values of the ratio parameters for the specific selection;
calculating an error value based on the difference between the reconstructed ratio values and the specific selection of ratio parameter values;
determining a sum of quantized index values; and
selecting at least one quantized index value to increment such that the sum of quantized index values is equal to an expected index sum.

24. A method for decoding an audio object parameter, wherein the audio object parameter is encoded by
obtaining, for time-frequency elements of a frame comprising more than one time element and more than one frequency element, a plurality of ratio parameters for an audio object within an audio environment, the audio environment comprising more than one audio object and the ratio parameters configured to identify a distribution of a specific object within the object part of the total audio environment and for a specific time-frequency element;
quantizing selections of the ratio parameters, wherein the selections are associated with audio objects within a specific frame time-frequency element;
encoding a first set of the selections of ratio parameters based on an indexing of the selections; and
encoding the remaining selections of the ratio parameters for the frame based on a differential encoding of the selections based on the first set of selection of ratio parameters or a precedingly indexed time element or frequency element selection of ratio parameters,
wherein the quantizing the selection of the ratio parameters comprises:
quantizing, using a lowest nearest neighbour scalar quantization, ratio values within a specific selection to obtain quantization index values;
calculating reconstructed values of the ratio parameters for the specific selection;
calculating an error value based on the difference between the reconstructed ratio values and the specific selection of ratio parameter values;
determining a sum of quantized index values; and
selecting at least one quantized index value to increment such that the sum of quantized index values is equal to an expected index sum,
the method comprising:
obtaining a bitstream comprising encoded ratio parameters, for time-frequency elements of a frame comprising more than one time element and more than one frequency element, the ratio parameters associated with audio object within an audio environment, the audio environment comprising more than one audio object and the ratio parameters configured to identify a distribution of a specific object within the object part of the total audio environment and for a specific time-frequency element;
decoding a first set of a selection of ratio parameters based on an indexing of the selection; and
decoding the remaining selection of the ratio parameters for the frame based on a differential decoding of the selection based on the first set of the selection of ratio parameters or a precedingly indexed time element or frequency element selection of the ratio parameters.

25. A system comprising the first apparatus according to claim 1 and a further apparatus for decoding an audio object parameter encoded by the first apparatus, the further apparatus comprising at least one processor and at least one memory storing instructions that, when executed by the at least one processor, cause the apparatus at least to perform:
obtaining a bitstream comprising encoded ratio parameters, for time-frequency elements of a frame comprising more than one time element and more than one frequency element, the ratio parameters associated with audio object within an audio environment, the audio environment comprising more than one audio object and the ratio parameters configured to identify a distribution of a specific object within the object part of the total audio environment and for a specific time-frequency element;
decoding a first set of a selection of ratio parameters based on an indexing of the selection; and
decoding the remaining selection of the ratio parameters for the frame based on a differential decoding of the selection based on the first set of the selection of ratio parameters or a precedingly indexed time element or frequency element selection of the ratio parameters.

26. The method of claim 23, further comprising, for decoding the encoded audio object parameter,
obtaining a bitstream comprising encoded ratio parameters, for time-frequency elements of a frame comprising more than one time element and more than one frequency element, the ratio parameters associated with audio object within an audio environment, the audio environment comprising more than one audio object and the ratio parameters configured to identify a distribution of a specific object within the object part of the total audio environment and for a specific time-frequency element;
decoding a first set of a selection of ratio parameters based on an indexing of the selection; and
decoding the remaining selection of the ratio parameters for the frame based on a differential decoding of the selection based on the first set of the selection of ratio parameters or a precedingly indexed time element or frequency element selection of the ratio parameters.
